(19) United States
(12) Patent Application Publication
(10) Pub. No.: US 2025/0209459 A1
(43) Pub. Date: Jun. 26, 2025

(54) MERCHANDISE SALES DATA PROCESSING APPARATUS AND MERCHANDISE SALES DATA PROCESSING METHOD

(71) Applicant: TOSHIBA TEC KABUSHIKI KAISHA, Tokyo (JP)

(72) Inventor: Tomohiro Sei, Tagata Shizuoka (JP)

(21) Appl. No.: 18/761,369

(22) Filed: Jul. 2, 2024

(30) Foreign Application Priority Data
Dec. 25, 2023 (JP) 2023-218552

(51) Int. Cl. G06Q 20/40; G06Q 20/18

(52) U.S. Cl. CPC G06Q 20/4014; G06Q 20/18

(57) ABSTRACT

A merchandise sales data processing apparatus according to an embodiment includes a registration unit, a determination unit, an identification unit, and a control unit. The registration unit registers, in a memory, a plurality of types of identification information related to identification of a user. The determination unit determines, from the plurality of types, a type of each of a plurality of pieces of the identification information used for the identification of the user. The identification unit identifies the user based on the identification information corresponding to the respective determined type of the plurality of pieces of the identification information and input information input from the user corresponding to the respective type of the plurality of pieces of the identification information. The control unit permits the user to use a service related to a commercial transaction when the user is identifiable by the identification unit.

### CROSS-REFERENCE TO RELATED APPLICATION

This application is based upon and claims the benefit of priority from Japanese Patent Application No. 2023-218552, filed on Dec. 25, 2023, the entire contents of which are incorporated herein by reference.

### FIELD

An embodiment of the disclosure relates to a merchandise sales data processing apparatus and a merchandise sales data processing method.

### BACKGROUND

In related art, there is known a semi-self-service-type merchandise sales data processing system in which a store clerk performs, using a registration machine, a registration operation of a merchandise and a customer performs, using a checkout machine, a settlement operation of the merchandise subjected to the merchandise registration process. Meanwhile, a full-self-service-type merchandise sales data processing system in which a customer performs a registration operation of a merchandise and a settlement operation of the merchandise is also common.

In such a system of the semi-self-service-type or the full-self-service-type, it is common that merchandise registration information subjected to a merchandise registration process using a registration machine is retrieved by a checkout machine and a settlement process is performed based on the merchandise registration information.

When performing a settlement operation using a payment medium other than cash at a merchandise sales data processing apparatus such as a checkout machine, a customer specifies a payment medium (a credit card, an electronic money card, an information terminal for electronic money or code settlement, a debit card, a point card, a prepaid card, or the like). Then, the customer causes a reading apparatus to read information stored in the specified payment medium, and thus the merchandise sales data processing apparatus performs a settlement process using the information.

Thus, in the related art, there is a situation in which an operation of reading the information from the payment medium is required when performing the settlement process. Such an operation may hinder a smooth settlement process.

Due to an increase in security awareness in recent years, there is a demand for a settlement method that ensures high security. However, such a method is limited to several methods using biometric authentication or the like, and there are not many options for a settlement method ensuring high security.

### DESCRIPTION OF THE DRAWINGS

FIG. 1 shows an example of a disposition state of a merchandise sales data processing system in a store according to an embodiment.

FIG. 2 shows an example of a connection relationship of the merchandise sales data processing system according to the embodiment.

FIG. 3 is a perspective view showing an example of an appearance of a registration machine according to the embodiment.

FIG. 4 is a perspective view showing an example of an appearance of a checkout machine according to the embodiment.

FIG. 5 is a block diagram showing an example of a hardware configuration of the registration machine according to the embodiment.

FIG. 6 is a block diagram showing an example of a hardware configuration of a store server according to the embodiment.

FIG. 7 is a memory map showing an example of a memory configuration of a membership information unit according to the embodiment.

FIG. 8 is a block diagram showing an example of a hardware configuration of a customer server according to the embodiment.

FIG. 9 is a memory map showing an example of a memory configuration of a membership management unit according to the embodiment.

FIG. 10 is a block diagram showing an example of a hardware configuration of the checkout machine according to the embodiment.

FIG. 11 is a block diagram showing an example of a hardware configuration of a membership registration terminal according to the embodiment.

FIG. 12 is a sequence diagram showing an example of a flow of a process among the registration machine, the store server, the customer server, and the checkout machine according to the embodiment.

FIG. 13 is a functional block diagram showing an example of a functional configuration of the registration machine, the store server, the customer server, and the checkout machine according to the embodiment.

FIG. 14 is a flowchart showing an example of a flow of a control process of the membership registration terminal according to the embodiment.

FIG. 15 is a flowchart showing an example of a flow of a control process of the registration machine according to the embodiment.

FIG. 16 is a flowchart showing an example of a flow of a control process of the store server according to the embodiment.

FIG. 17 is a flowchart showing an example of a flow of a control process of the customer server according to the embodiment.

FIG. 18 is a flowchart showing an example of a flow of a control process of the checkout machine according to the embodiment.

FIG. 19 shows an example of a medium selection screen displayed to a member A by the checkout machine according to the embodiment.

FIG. 20 shows an example of a medium selection screen displayed to a member B by the checkout machine according to the embodiment.

### DETAILED DESCRIPTION

In general, according to one embodiment, a merchandise sales data processing apparatus and a merchandise sales data processing method that improve convenience of a settlement process is provided.

A merchandise sales data processing apparatus according to an embodiment includes a registration unit, a determination unit, an identification unit, and a control unit. The registration unit registers, in a memory, a plurality of types of identification information related to identification of a user. The determination unit determines, from the plurality of types, a type of each of a plurality of pieces of the identification information used for the identification of the user. The identification unit identifies the user based on the identification information corresponding to the respective determined type of the plurality of pieces of the identification information and input information input from the user corresponding to the respective type of the plurality of pieces of the identification information. The control unit permits the user to use a service related to a commercial transaction when the user is identifiable by the identification unit.

Hereinafter, an embodiment will be described with reference to the drawings. In the embodiment described below, an example in which the embodiment is applied to a full-self-service-type or semi-self-service-type checkout system used in a store such as a supermarket will be described. In the embodiment, a merchandise sales data processing system includes a registration machine, a store server, and a checkout machine.

In the embodiment, a membership number is used as an example of member identification information for identifying a member. The membership number is information for identifying the member, and is issued by a store or a company operating the store when a customer becomes a member. The membership number is magnetically or electrically stored in, for example, a membership card. The membership number may be printed on the membership card as a code symbol.

The disclosure is not limited to the embodiment. For example, the merchandise sales data processing system may include at least the registration machine and the checkout machine. The checkout machine is an example of the merchandise sales data processing apparatus disclosed herein. The merchandise sales data processing apparatus may be implemented by a single apparatus in which the registration machine and the checkout machine are integrated. The member identification information may be information for identifying the member other than the membership number. For example, the member identification information may be a membership code issued by the store or the company operating the store.

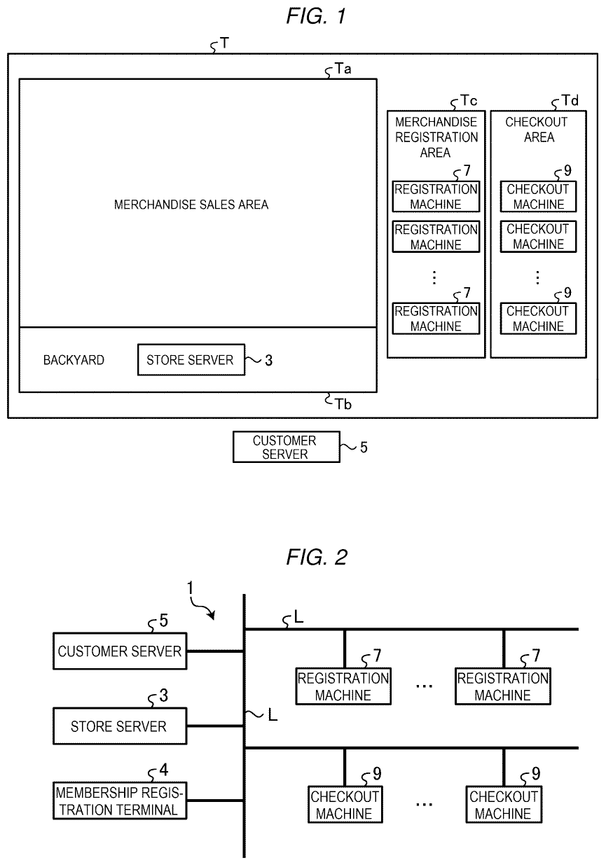

FIG. 1 shows an example of a disposition state in a store T of a merchandise sales data processing system 1 (see FIG. 2) according to the embodiment. As shown in FIG. 1, the store T has a merchandise sales area Ta, a backyard Tb, a merchandise registration area Tc, and a checkout area Td.

In the merchandise sales area Ta, a merchandise sold in the store is displayed. A customer puts a merchandise to be purchased into a shopping basket, a cart, or the like while moving in the merchandise sales area Ta. A store server 3 is provided in the backyard Tb.

The merchandise registration area Tc is provided adjacent to the merchandise sales area Ta. One or a plurality of registration machines 7 are provided in the merchandise registration area Tc. In the embodiment, each registration machine 7 is operated by a store clerk of the store. However, the registration machine 7 may also be operated by the customer. The checkout area Td is provided in the vicinity of an exit of the store T. One or a plurality of checkout machines 9 are provided in the checkout area Td. In the embodiment, each checkout machine 9 is operated by the customer.

The number of registration machines 7 provided in the merchandise registration area Tc and the number of checkout machines 9 provided in the checkout area Td may be the same or different. A customer server 5 is provided inside the store T, or may alternatively be provided outside the store T (for example, in a cloud server). By providing the customer server 5 outside the store T, it is possible to improve security related to customer information and the like as compared to a case where the customer server 5 is provided inside the store T.

When entering the store T, the customer selects a merchandise to be purchased in the merchandise sales area Ta. When shopping ends, the customer moves to the merchandise registration area Tc. In the merchandise registration area Tc, the store clerk or the customer performs, using the registration machine 7, a merchandise registration operation of the merchandise purchased by the customer.

The registration machine 7 performs a merchandise registration process of the merchandise subjected to the merchandise registration operation. When the merchandise registration process is finished for all purchased merchandises, the customer carries the merchandises and moves to any checkout machine 9. The customer who moves to the checkout machine 9 performs a checkout operation.

When the checkout operation is performed, the checkout machine 9 performs a settlement process on the merchandise subjected to the merchandise registration process. The customer who finishes the checkout leaves the store T with the merchandise. The backyard Tb is an area where the customer cannot normally enter, and is, for example, an area where a business process of the store T is performed.

Hereinafter, a connection relationship between the store server 3, a membership registration terminal 4, the customer server 5, the registration machine 7, and the checkout machine 9 will be described. FIG. 2 shows a connection relationship between apparatuses in the store T including the merchandise sales data processing system 1. The store server 3, the membership registration terminal 4, the customer server 5, the registration machine 7, and the checkout machine 9 are connected by a communication line L such as a local area network (LAN) and can communicate with one another.

The registration machine 7 captures an image (hereinafter collectively referred to as “merchandise image”) of the merchandise or a code symbol (bar code, two-dimensional code, or the like) attached to the merchandise. Then, the registration machine 7 identifies the merchandise from the captured merchandise image using known general object recognition (object recognition or package recognition) and acquires a merchandise code (an example of merchandise identification information).

A scanner 82 may be a scan-type scanner that acquires the merchandise code by scanning a code symbol (for example, a bar code or a two-dimensional code) attached to the merchandise and decoding received laser light.

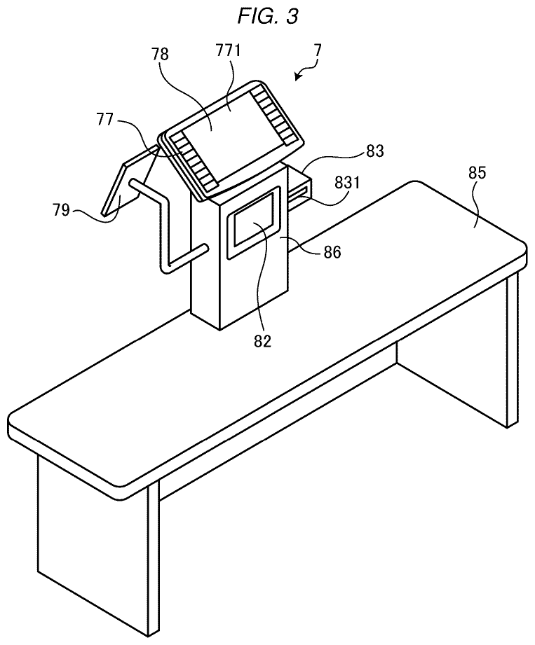

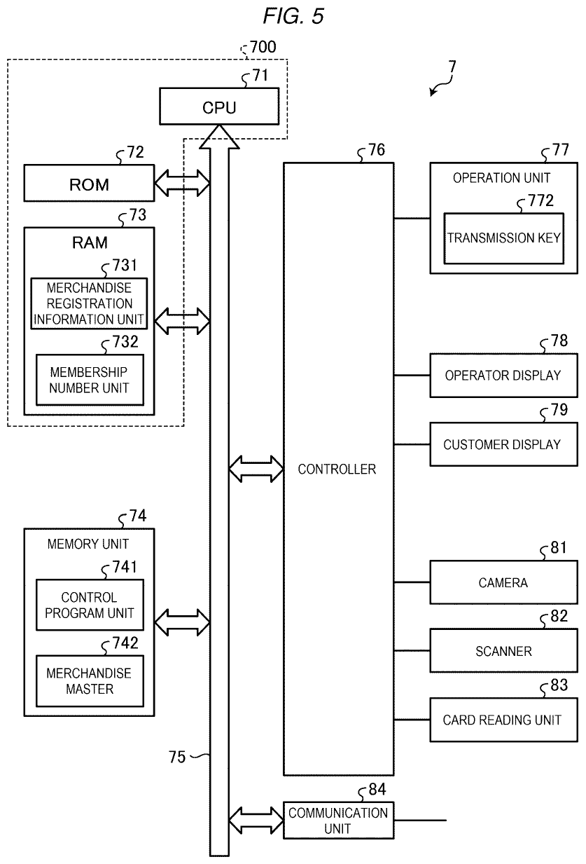

The registration machine 7 performs the merchandise registration process related to the merchandise based on the acquired merchandise code. The merchandise registration process includes a process of reading the merchandise identification information (a merchandise name, a merchandise price, and the like) of the merchandise based on the read merchandise code, displaying the merchandise identification information on an operator display 78 (see FIG. 3) and a customer display and 79, storing the merchandise identification information in a merchandise information unit 731 (see FIG. 5).

In the embodiment, the merchandise identification information displayed on the operator display 78 is viewed by the store clerk. However, the merchandise identification information may be viewed by the customer. In the embodiment, an operator includes the store clerk or the customer.

The registration machine 7 reads a membership number for identifying a member from a membership card and stores the membership number in a membership number unit 732 (see FIG. 5). The membership card is issued to a member who performs membership registration to be described later. The membership card may have a function as a point card that stores a point issued by the store.

The registration machine 7 transmits, to the store server 3, the merchandise registration information subjected to the merchandise registration process. When the membership number is stored in the membership number unit 732, the registration machine 7 associates the membership number with the merchandise registration information, and transmits the membership number and the merchandise registration information to the store server 3.

The store server 3 manages sales of the merchandise sold in the store T. The store server 3 manages the sales of the merchandise sold in the store T based on the merchandise registration information and settlement information (collectively referred to as “sales data”) received from the checkout machine 9.

The store server 3 stores the membership number and the merchandise registration information received from the registration machine 7 in association with each other. The store server 3 transmits authentication information received from the checkout machine 9 to the customer server 5, and stores the membership number and payment medium information associated with the authentication information received from the customer server 5 in association with the previously-stored membership number.

That is, the store server 3 stores the merchandise registration information and the payment medium information in association with the membership number. In addition to the above, the store server 3 may store, in association with the membership number, point information indicating the number of points accumulated by the customer using the membership card. In this case, the points may be used to purchase the merchandise. For example, one point may be converted into one yen and used as a full amount or a partial amount of payment for the purchased merchandise.

The payment medium information is code information or number information that is registered in advance by the customer for identifying a payment medium used by the customer for payment (settlement process) of the purchased merchandise. The payment medium information can be said to be information indicating an available settlement service, and thus is an example of information indicating an available service. When or after membership registration, the customer registers a payment medium used for payment.

The payment medium that can be registered is, for example, a credit card (for example, a company-specific credit card such as a credit card A issued by Company A and a credit card B issued by Company B), electronic money (for example, company-specific electronic money such as electronic money A issued by Company A and electronic money B issued by Company B), or code settlement (settlement means using an application stored in a smartphone or an information terminal, and as an example, there is company-specific code settlement such as code settlement A issued by Company A and code settlement B issued by Company B), a debit card (for example, a company-specific debit card such as a debit card A issued by Company A and a debit card B issued by Company B), or a prepaid card (for example, a company-specific prepaid card such as a prepaid card A issued by Company A and a prepaid card B issued by Company B).

When the membership card also has a function as a point card, the membership card may also be registered as an available payment medium. Thus, since the payment medium registered in advance by the member can be used as a settlement medium, the available payment medium may be different for each member. The payment medium that can be registered may be any payment medium other than those described above that is available for payment other than cash.

The customer server 5 is provided outside the store T (for example, at a headquarter of the company) as a server separate from the store server 3. The customer server 5 is, for example, a cloud server. The customer server 5 stores the authentication information and the payment medium information of the customer in association with each other for each membership number.

The authentication information (an example of identification information) is a plurality of pieces of information that can be combined to uniquely identify the customer (member). The authentication information includes, for example, a mobile phone number, a my number, a name, a user name (a freely-registered character string through which the user can be identified), a personal identification number (for example, any four-digit number), a character string representing favorite food, and a face image. Information such as the mobile phone number, the my number, the name, and the face image that can uniquely identify the member alone is an example of first information. Information that cannot uniquely identify the member alone such as the personal identification number and the character string representing favorite food is an example of second information.

The authentication information is not limited to those described above, and may be any plurality of pieces of information that can be combined to uniquely identify the customer. A functional configuration of the customer server 5 may be incorporated in the store server 3, and the customer server 5 may be integrated with the store server 3.

The membership registration terminal 4 is an apparatus used when the customer performs the membership registration. The customer registers the authentication information when performing the membership registration. When the customer performs the membership registration, for example, a procedure of the membership registration is performed on the membership registration terminal 4 provided at a service counter, or the procedure of the membership registration is performed on the membership registration terminal 4 implemented as a portable terminal such as a smartphone or a tablet terminal.

In membership registration, the customer registers the authentication information. For example, when registering the mobile phone number, the my number, the name, the user name, the personal identification number, or the character string representing favorite food, the customer inputs corresponding information via an authentication information input screen for inputting such information displayed on the membership registration terminal 4 and thus registers the authentication information on the membership registration terminal 4.

For example, when the face image is registered as the authentication information, the customer captures the face image on the membership registration terminal 4 to register the face image as the authentication information on the membership registration terminal 4. In this way, when performing the membership registration, the customer registers a plurality of pieces of authentication information on the membership registration terminal 4 by a method corresponding to authentication information adopted by the store T.

In the embodiment, all of the mobile phone number, the my number, the name, the user name, the personal identification number, the character string representing favorite food, and the face image are registered as the authentication information. The customer may register, as the authentication information, a number of pieces of information equal to or larger than a number specified by the store in advance from the above-described information. The membership registration terminal 4 issues the membership number for identifying the customer when performing the membership registration, and stores a plurality of pieces of acquired authentication information in association with the membership number.

When performing the membership registration, the customer registers, from the membership registration terminal 4, number information (an example of first number information) indicating the number of pieces of the authentication information used for member identification. For example, the customer registers the number information on the membership registration terminal 4 by inputting corresponding information (numerical value) via a number information input form for inputting the number information provided on the authentication information input screen displayed on the membership registration terminal 4.

The number information is used to improve security in the settlement process. For example, after the membership number is identified by the combination of the plurality of pieces of authentication information, the number information associated with the membership number is compared with a number input by the checkout machine 9 as number information (an example of the second number information) indicating the authentication information used for the settlement process, which is input by the customer at the start of the settlement process. At this time, when the two numbers do not match, the checkout machine 9 stops the settlement process.

Accordingly, the settlement process is not performed unless a numerical value matching the number information used for member identification registered at the time of the membership registration is input, and thus safety of the settlement process can be improved.

When performing the membership registration, the customer registers, from the membership registration terminal 4, the payment medium information for identifying one or a plurality of payment media available for payment by the member.

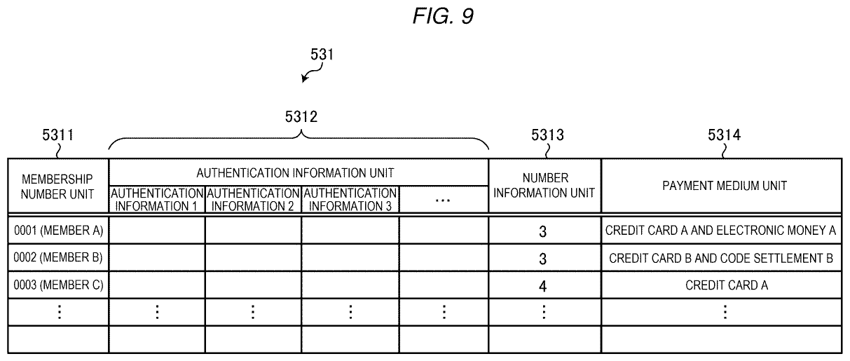

As an example, as will be described later in detail with reference to FIG. 9, it is assumed that a member A inputs and registers, from the membership registration terminal 4, two types of payment media, that is, the credit card A and the electronic money A at the time of the membership registration. It is assumed that a member B inputs and registers, from the membership registration terminal 4, two types of payment media, that is, the credit card B and the code settlement B at the time of the membership registration. It is assumed that a member C inputs and registers, from the membership registration terminal 4, one type of payment medium, that is, the credit card A at the time of the membership registration.

The membership registration terminal 4 stores the payment medium information indicating the payment medium registered by the customer as described above in association with the issued membership number.

The membership registration terminal 4 associates the plurality of pieces of authentication information, the number information used for member identification, and the payment medium information with the issued membership number and transmits such information to the customer server 5. The customer server 5 stores the authentication information and the payment medium information indicating the payment medium received from the membership registration terminal 4 in association with the simultaneously received membership number (that is, performs the membership registration).

The membership registration terminal 4 may not transmit, to the customer server 5, the information in which the plurality of pieces of authentication information, the number information used for member identification, and the payment medium information are associated with the issued membership number. In this case, the membership registration terminal 4 may manage the information.

The checkout machine 9 acquires the plurality of pieces of authentication information from the member and transmits the authentication information to the store server 3. The checkout machine 9 receives, from the store server 3, the merchandise registration information obtained by performing the merchandise registration process by the registration machine 7 for the merchandise purchased by the member identified by a combination of the transmitted plurality of pieces of authentication information, and performs the settlement process for the merchandise.

The settlement process refers to a process of displaying a total amount and a tax amount of the merchandise related to one transaction subjected to the merchandise registration process, and calculating and displaying change based on received money received from the customer when paying in cash, a process between a company that issues a payment medium when using the payment medium other than cash, a process of issuing a receipt on which merchandise information and settlement information (a total amount, a received amount, a change amount, and the like) are printed, and the like.

The checkout machine 9 receives the payment medium information from the store server 3. When there are a plurality of available payment media based on the received payment medium information, the checkout machine 9 displays a medium selection screen for selecting one payment medium. When one payment medium is selected, the checkout machine 9 performs the settlement process using the payment medium.

When there is one available payment medium based on the received payment medium information, the checkout machine 9 may perform the settlement process using the payment medium without displaying the medium selection screen.

Hereinafter, a schematic configuration of the registration machine 7 will be described. FIG. 3 is a perspective view showing an example of an appearance of the registration machine 7. As shown in FIG. 3, the registration machine 7 is arranged on a surface of a counter 85 having a substantially rectangular surface. The registration machine 7 is implemented based on the scanner 82 including a reading window provided in an arrangement surface 86. The scanner 82 captures an image of a merchandise passing in front of the reading window. The scanner 82 identifies the merchandise based on the captured image of the merchandise.

The registration machine 7 includes the operator display 78 and an operation unit 77 above the scanner 82. The operator display 78 displays, toward an operator (the store clerk operating the registration machine 7), a registration screen for registering a sold merchandise, a subtotal screen indicating a subtotal amount, and the like.

A touch panel 771 is provided on a surface of the operator display 78 as a part of the operation unit 77. The operation unit 77 is provided on both sides of the operator display 78. The operation unit 77 including the touch panel 771 functions as a user interface that assists input of the merchandise registration information.

A card reading unit 83 is provided on a right side surface of the registration machine 7. The card reading unit 83 magnetically or electrically reads information relative to a card (medium) inserted through an insertion slot 831. The card reading unit 83 reads, from a membership card inserted from the insertion slot 831, for example, a membership number for identifying a member (customer) who owns the membership card.

A member refers to a customer who performs a predetermined membership registration procedure. In the embodiment, the insertion slot 831 faces a store clerk side of the card reading unit 83, and the store clerk inserts the membership card received from the member. Alternatively, the insertion slot 831 may be provided on a customer side (a side opposite to the store clerk side), and the customer may insert the membership card.

On the customer side of the registration machine 7, the customer display 79 is provided in a state in which a display surface thereof faces a side opposite to a display surface of the operator display 78. The customer display 79 displays information to a customer including a member.

The registration machine 7 includes a camera 81 (see FIG. 5). The camera 81 captures a face image of a non-member customer. The registration machine 7 transmits, to the store server 3, merchandise registration information of a merchandise purchased by the non-member and information about the face image captured by the camera 81 in association with each other. When transmitting the merchandise registration information to the store server 3, the registration machine 7 displays a message recommending the non-member to become a member on the customer display 79.

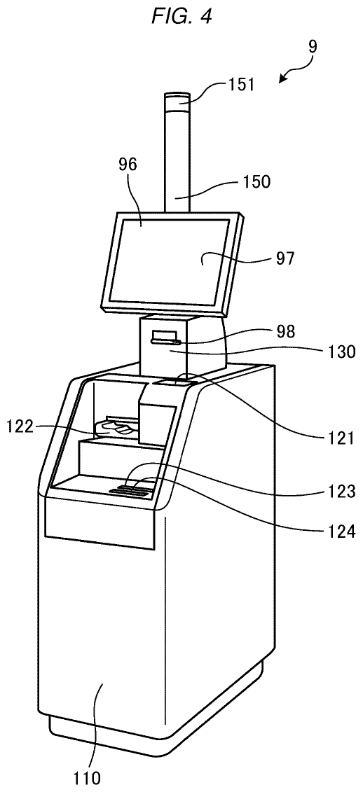

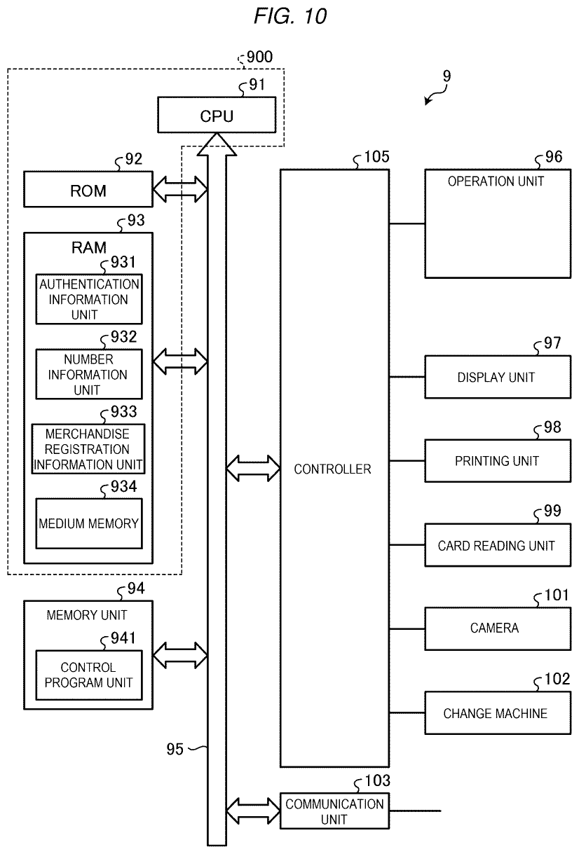

Hereinafter, a schematic configuration of the checkout machine 9 will be described. FIG. 4 is a perspective view showing an example of an appearance of the checkout machine 9. As shown in FIG. 4, the checkout machine 9 includes a first housing 110 and a second housing 130. The first housing 110 includes a change machine 102 and a control unit 900 (see FIG. 10). The second housing 130 is placed on an upper surface of the first housing 110, and includes a printing unit 98 and the like.

A display 97 is attached to an upper side of the second housing 130, and an operation unit 96 including a touch panel is provided on a surface of the display 97. The display 97 includes, for example, a liquid crystal panel, and displays information about an operation state of the checkout machine 9. The display 97 displays, to the member, the medium selection screen for selecting the payment medium to be used, which will be described later.

When cash is used as the payment medium, the change machine 102 receives a coin or a bill to be paid, and dispenses change when there is change.

The change machine 102 includes a coin insertion slot 121, a bill insertion slot 123, a bill dispensing slot 124, and a coin dispensing unit 122. The change machine 102 internally stores a bill inserted into the bill insertion slot 123 and a coin inserted into the coin insertion slot 121.

The change machine 102 dispenses bill change to the bill dispensing slot 124 in response to change dispensing request from the control unit 900 (see FIG. 10). The change machine 102 dispenses coin change to the coin dispensing unit 122 in response to the change dispensing request from the control unit 900.

The printing unit 98 is provided in the second housing 130, and issues a receipt on which the merchandise registration information and the settlement information of the merchandise subjected to the settlement process are printed under control of the control unit 900.

The checkout machine 9 includes a columnar pole 150 extending upward from a rear upper surface of the first housing 110. The pole 150 includes a light-emitting unit 151 that emits blue or red light at an upper tip portion. The light-emitting unit 151 emits light while changing the color according to a process state of the checkout machine 9 to alert the store clerk. A process state in which light is to be emitted, a color of emitted light, and a light emission pattern can be appropriately set.

When the customer or the member operates the checkout machine 9, the checkout machine 9 performs a process of paying a price of a merchandise, that is, the settlement process, using a payment medium such as cash, a credit card or electronic money other than cash.

Hereinafter, a hardware configuration of the registration machine 7 will be described. FIG. 5 is a block diagram showing an example of the hardware configuration of the registration machine 7. As shown in FIG. 5, the registration machine 7 includes a central processing unit (CPU) 71, which is an example of a processor, a read-only memory (ROM) 72, a random access memory (RAM) 73, a memory unit 74, and the like.

The CPU 71 is a control entity of the registration machine 7. The ROM 72 stores various programs. The RAM 73 loads programs and various types of data. The memory unit 74 stores various programs. The CPU 71, the ROM 72, the RAM 73, and the memory unit 74 are connected via a bus 75.

The CPU 71, the ROM 72, and the RAM 73 constitute a control unit 700. That is, the CPU 71 operates according to a control program that is stored in the ROM 72 or the memory unit 74 and loaded into the RAM 73, and thus the control unit 700 performs a control process of the registration machine 7 to be described later.

The RAM 73 includes the merchandise information unit 731 and the membership number unit 732. The merchandise information unit 731 stores the merchandise registration information of the merchandise subjected to the merchandise registration process. The membership number unit 732 stores the membership number of the member read by the card reading unit 83 to be described later.

The memory unit 74 is implemented by a non-volatile memory such as a hard disc drive (HDD) or a flash memory that retains stored information even when power is off, and includes a control program unit 741 that stores the control program for operating the registration machine 7 and a merchandise master 742. The merchandise master 742 stores, for each merchandise, merchandise information of each merchandise in association with merchandise identification information (for example, a merchandise code) for identifying the merchandise.

The control unit 700 is connected to the operation unit 77, the operator display 78, the customer display 79, the camera 81, the scanner 82, and the card reading unit 83 via the bus 75 and a controller 76.

The operation unit 77 includes a transmission key 772. The transmission key 772 is operated when the merchandise registration information subjected to the merchandise registration process by the registration machine 7 is transmitted to the store server 3 in association with the membership number stored in the membership number unit 732. In the case of the non-member customer, when the transmission key 772 is operated, the merchandise registration information subjected to the merchandise registration process by the registration machine 7 is transmitted to the store server 3 in association with the face image of the customer captured by the camera 81.

The operator display 78 displays, to the store clerk, the merchandise registration information of the merchandise subjected to the merchandise registration process. Specifically, the operator display 78 reads the merchandise information stored in the merchandise master 742 along with the merchandise registration process, and displays the merchandise information as the merchandise registration information. The customer display 79 displays the merchandise registration information to the customer (member).

The camera 81 is provided, for example, in the vicinity of the customer display 79 to capture the face image of the non-member during a transaction. The scanner 82 captures an image of the merchandise. Alternatively, the scanner 82 captures an image of a code symbol attached to the merchandise. The card reading unit 83 magnetically or electrically reads card information including the membership number from the inserted membership card.

The control unit 700 is connected to the communication unit 84 via the bus 75. The communication unit 84 is communicably connected, via the communication line L, to the store server 3, the membership registration terminal 4, the customer server 5, and the checkout machine 9.

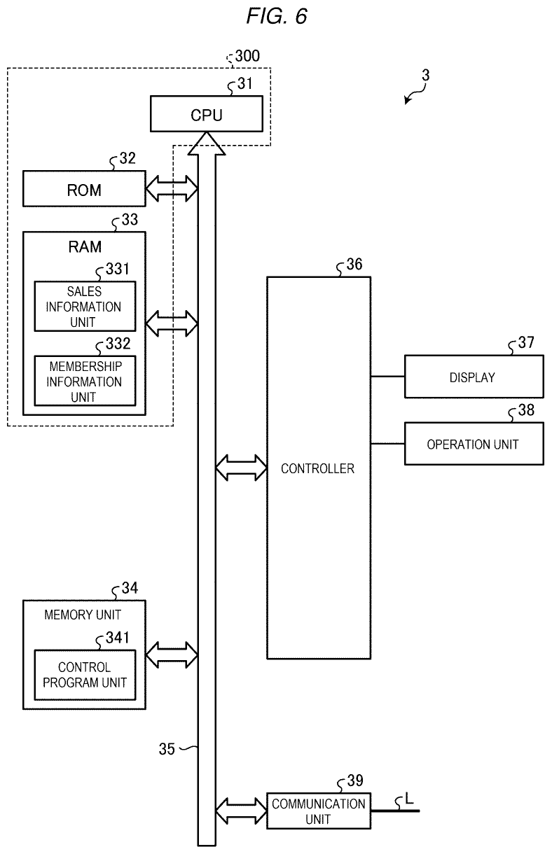

Hereinafter, a hardware configuration of the store server 3 will be described. FIG. 6 is a block diagram showing an example of the hardware configuration of the store server 3. As shown in FIG. 6, the store server 3 includes a CPU 31, which is an example of a processor, a ROM 32, a RAM 33, a memory unit 34, and the like.

The CPU 31 is a control entity of the store server 3. The ROM 32 stores various programs. The RAM 33 loads programs and various types of data. The memory unit 34 stores various programs. The CPU 31, the ROM 32, the RAM 33, and the memory unit 34 are connected via a bus 35.

The CPU 31, the ROM 32, and the RAM 33 constitute a control unit 300. That is, the CPU 31 operates according to a control program that is stored in the ROM 32 or the memory unit 34 and loaded into the RAM 33, and thus the control unit 300 performs a control process of the store server 3 to be described later.

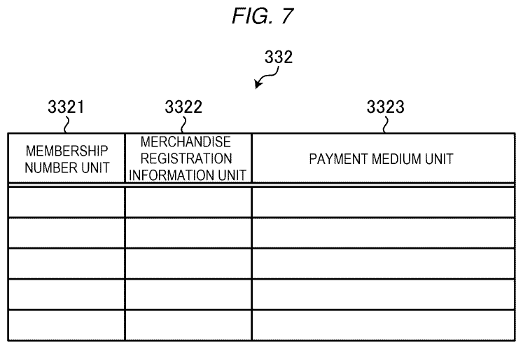

The RAM 33 includes a sales information unit 331 and a membership information unit 332. The sales information unit 331 cumulatively stores the sales data (the merchandise registration information and the settlement information of the merchandise subjected to the settlement process) received from the checkout machine 9, and manages sales of the store T. The membership information unit 332 stores information received from the registration machine 7 and information received from the customer server 5 for each membership number. The membership information unit 332 will be described later with reference to FIG. 7.

The memory unit 34 is configured by a non-volatile memory such as an HDD or a flash memory that retains stored information even when power is off, and includes a control program unit 341. The control program unit 341 stores the control program for driving the store server 3.

The control unit 300 is connected to a display unit 37 and an operation unit 38 via the bus 35 and a controller 36. The display unit 37 is, for example, a liquid crystal display, and displays information for an operator who operates the store server 3. The operation unit 38 is, for example, a keyboard, and is operated by the operator of the store server 3.

The control unit 300 is connected to a communication unit 39 via the bus 35. The communication unit 39 is communicably connected, via the communication line L, to the registration machine 7, the membership registration terminal 4, the customer server 5, and the checkout machine 9.

Hereinafter, the membership information unit 332 will be described. FIG. 7 is a memory map showing a memory configuration of the membership information unit 332. As shown in FIG. 7, the membership information unit 332 includes a membership number unit 3321, a merchandise registration information unit 3322, and a payment medium unit 3323.

The membership number unit 3321 stores the membership number among the membership number and the merchandise registration information received in association with each other from the registration machine 7.

The merchandise registration information unit 3322 stores, in association with the membership number stored in the membership number unit 3321, the merchandise registration information among the membership number and the merchandise registration information received in association with each other from the registration machine 7.

The payment medium unit 3323 stores, in association with the membership number stored in the membership number unit 3321 that is the same as the received membership number, the payment medium information among the membership number, the merchandise registration information, and the payment medium information received in association with one another from the customer server 5 to be described later.

That is, the membership information unit 332 stores, for each membership number stored in the membership number unit 3321, the merchandise registration information of the merchandise purchased by the customer identified by the membership number and the payment medium information for identifying the payment medium that is registered in advance by the customer and is available for settlement.

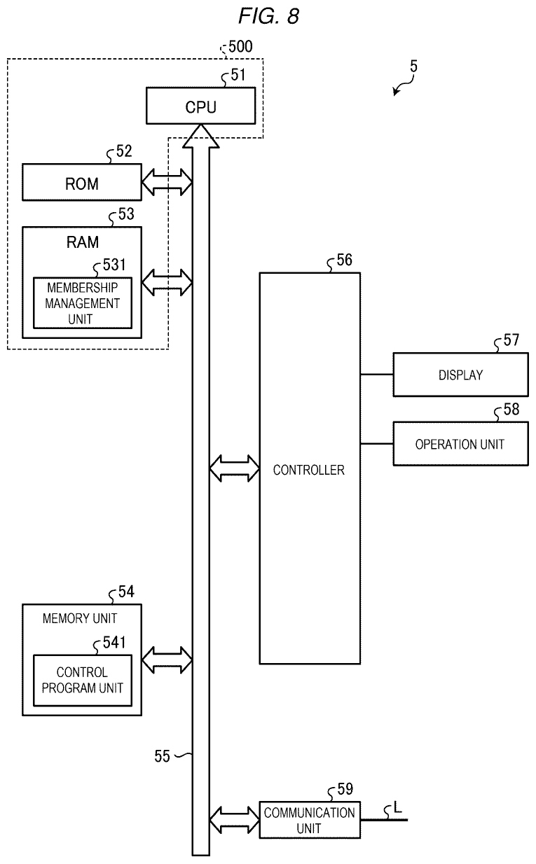

Hereinafter, a hardware configuration of the customer server 5 will be described. FIG. 8 is a block diagram showing an example of the hardware configuration of the customer server 5. As shown in FIG. 8, the customer server 5 includes a CPU 51, which is an example of a processor, a ROM 52, a RAM 53, a memory unit 54, and the like.

The CPU 51 is a control entity of the customer server 5. The ROM 52 stores various programs. The RAM 53 loads programs and various types of data. The memory unit 54 stores various programs. The CPU 51, the ROM 52, the RAM 53, and the memory unit 54 are connected via a bus 55.

The CPU 51, the ROM 52, and the RAM 53 constitute a control unit 500. That is, the CPU 51 operates according to a control program that is stored in the ROM 52 or the memory unit 54 and loaded into the RAM 53, and thus the control unit 500 performs a control process of the customer server 5 to be described later.

The RAM 53 includes a membership management unit 531 that stores information on the member whose membership is registered. The membership management unit 531 will be described later with reference to FIG. 9.

The memory unit 54 is configured by a non-volatile memory such as an HDD or a flash memory that retains stored information even when power is off, and includes a control program unit 541. The control program unit 541 stores the control program for driving the customer server 5.

The control unit 500 is connected to a display unit 57 and an operation unit 58 via the bus 55 and a controller 56. The display unit 57 is, for example, a liquid crystal display, and displays information for an operator who operates the customer server 5. The operation unit 58 is, for example, a keyboard, and is operated by the operator of the customer server 5.

The control unit 500 is connected to a communication unit 59 via the bus 55. The communication unit 59 is communicably connected, via the communication line L, to the registration machine 7, the store server 3, the checkout machine 9, and the membership registration terminal 4.

Hereinafter, the membership management unit 531 will be described. The membership management unit 531 is an example of a memory. FIG. 9 is a memory map showing a memory configuration of the membership management unit 531. As shown in FIG. 9, the membership management unit 531 includes a membership number unit 5311, an authentication information unit 5312, a number information unit 5313, and a payment medium unit 5314.

The membership number unit 5311 stores the membership number among the membership number, the plurality of pieces of authentication information, the number information used for member identification, and the payment medium information received in association with one another from the membership registration terminal 4.

The authentication information unit 5312 stores, in association with the membership number stored in the membership number unit 5311, the plurality of pieces of authentication information among the membership number, the plurality of pieces of authentication information, and the payment medium information received in association with one another from the membership registration terminal 4, or an authentication identification code for identifying each of the plurality of pieces of authentication information.

The number information unit 5313 stores the number information used for member identification among the membership number, the plurality of pieces of authentication information, the number information used for member identification, and the payment medium information received in association with one another from the membership registration terminal 4.

The payment medium unit 5314 stores, in association with the membership number stored in the membership number unit 5311, the payment medium information among the membership number, the plurality of pieces of authentication information, the number information used for member identification, and the payment medium information received in association with one another from the membership registration terminal 4.

In FIG. 9, as an example, for the member A having a membership number of 0001, the member B having a membership number of 0002, and the member C having a membership number of 0003, the plurality of pieces of authentication information stored in the authentication information unit 5312, the number information used for member identification stored in the number information unit 5313, and the payment medium information stored in the payment medium unit 5314 are shown.

The member A registers three as the number information used for member identification, and payment media available for paying for the purchased merchandise are the credit card A and the electronic money A. That is, the member A can perform the settlement process only when three is input as the number of pieces of authentication information to be used at the start of the settlement process. The member A can use the credit card A or the electronic money A to pay a price (settlement process).

The member B registers three as the number information used for member identification, and payment media available for paying for the purchased merchandise are the credit card B and the code settlement B. That is, the member B can perform the settlement process only when three is input as the number of pieces of authentication information to be used at the start of the settlement process. The member B can use the credit card B or the code settlement B to pay a price (settlement process).

The member C registers four as the number information used for member identification, and a payment medium available for paying for the purchased merchandise is the credit card A. That is, the member C can perform the settlement process only when four is input as the number of pieces of authentication information to be used at the start of the settlement process. The member C can use only the credit card A to pay a price (settlement process).

Hereinafter, a hardware configuration of the checkout machine 9 will be described. FIG. 10 is a block diagram showing an example of the hardware configuration of the checkout machine 9. As shown in FIG. 10, the checkout machine 9 includes a CPU 91, which is an example of a processor, a ROM 92, a RAM 93, a memory unit 94, and the like.

The CPU 91 is a control entity of the checkout machine 9. The ROM 92 stores various programs. The RAM 93 loads programs and various types of data. The memory unit 94 stores various programs. The CPU 91, the ROM 92, the RAM 93, and the memory unit 94 are connected via a bus 95.

The CPU 91, the ROM 92, and the RAM 93 constitute the control unit 900. That is, the CPU 91 operates according to a control program that is stored in the ROM 92 or the memory unit 94 and loaded into the RAM 93, and thus the control unit 900 performs a control process of the checkout machine 9 to be described later.

The RAM 93 includes an authentication information unit 931, a number information unit 932, a merchandise registration information unit 933, and a medium memory 934.

The authentication information unit 931 stores the plurality of pieces of authentication information of the member acquired by an authentication acquisition unit 904 to be described later. The number information unit 932 stores the number information to be used in the settlement process, which is acquired by a number acquisition unit 901 to be described later. The merchandise registration information unit 933 stores the merchandise registration information that is received from the store server 3 and stored in the merchandise registration information unit 3322. The medium memory 934 stores the payment medium information that is received from the store server 3 and stored in the payment medium unit 3323.

The memory unit 94 is configured by a non-volatile memory such as an HDD or a flash memory that retains stored information even when power is off, and includes a control program unit 941. The control program unit 941 stores a control program for driving the checkout machine 9.

The control unit 900 is connected, via the bus 95 and a controller 105, to the operation unit 96, the display 97, the printing unit 98, the card reading unit 99, the camera 101, and the change machine 102. The display 97 displays information to the customer (member) who operates the checkout machine 9. The operation unit 96 is a keyboard including a touch panel provided on the surface of the display 97. The printing unit 98 prints the merchandise registration information and the settlement information of the merchandise subjected to the settlement process, and issues the receipt.

When the non-member uses the checkout machine 9, the card reading unit 99 receives insertion of a payment medium for settlement and reads information in the payment medium (for example, credit card information). The checkout machine 9 performs the settlement process of the merchandise purchased by the non-member based on the information read by the card reading unit 99. The checkout machine 9 displays, on the display 97, a message recommending the non-member customer to become a member when the settlement process of the customer is performed.

The camera 101 captures the face image of the non-member customer. The change machine 102 is used for settlement in cash.

The control unit 900 is connected to a communication unit 103 via the bus 95. The communication unit 103 is communicably connected, via the communication line L, to the registration machine 7, the store server 3, the customer server 5, and the membership registration terminal 4.

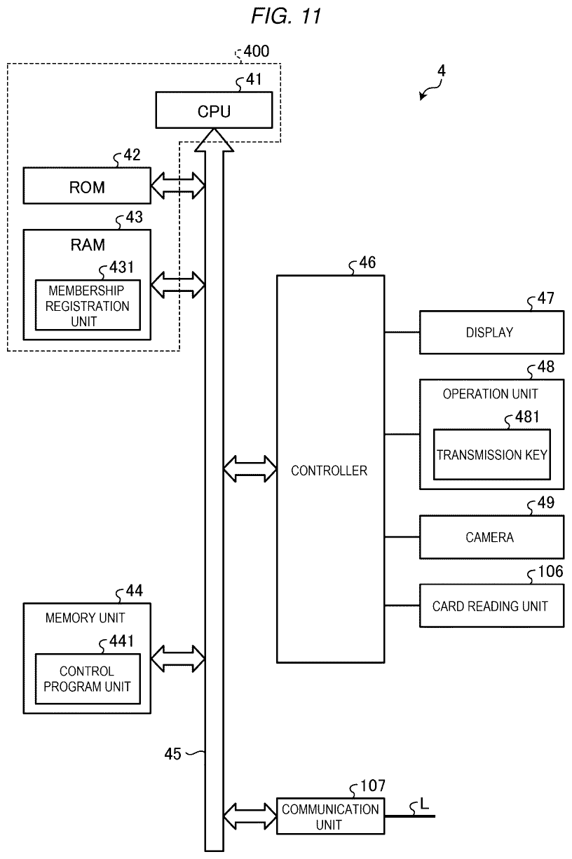

Hereinafter, a hardware configuration of the membership registration terminal 4 will be described. FIG. 11 is a block diagram showing the hardware configuration of the membership registration terminal 4. As shown in FIG. 11, the membership registration terminal 4 includes a CPU 41, which is an example of a processor, a ROM 42, a RAM 43, a memory unit 44, and the like.

The CPU 41 is a control entity of the membership registration terminal 4. The ROM 42 stores various programs. The RAM 43 loads programs and various types of data. The memory unit 44 stores various programs. The CPU 41, the ROM 42, the RAM 43, and the memory unit 44 are connected via a bus 45.

The CPU 41, the ROM 42, and the RAM 43 constitute a control unit 400. That is, the CPU 41 operates according to a control program that is stored in the ROM 42 or the memory unit 44 and loaded into the RAM 43, and thus the control unit 400 performs a control process of the membership registration terminal 4 to be described later.

The RAM 43 includes a membership registration unit 431. The membership registration unit 431 stores, in association with the membership number newly generated for the member whose membership is registered, the plurality of pieces of acquired authentication information and the payment medium information available for payment read by the card reading unit 106 from the payment medium inserted into the card reading unit 106.

The memory unit 44 is configured by a non-volatile memory such as an HDD or a flash memory that retains stored information even when power is off, and includes a control program unit 441. The control program unit 441 stores the control program for driving the membership registration terminal 4.

The control unit 400 is connected, via the bus 45 and a controller 46, to a display 47, an operation unit 48, a camera 49, and the card reading unit 106.

The display 47 displays information to the customer (member) or the store clerk who operates the membership registration terminal 4. The operation unit 48 includes a touch panel provided on a surface of the display 47, and is a keyboard including a transmission key 481. The customer inputs the authentication information via the authentication information input screen displayed on the display 47 and the operation unit 48. In this case, the control unit 400 acquires the input information as one of the plurality of pieces of authentication and information, stores the plurality of pieces of authentication information in the membership registration unit 431.

For example, the authentication information input screen includes a selection box for selecting a type of authentication information to be registered and an input box for inputting a character string corresponding to the selected type of authentication information.

The authentication information input screen further includes an operation element for shifting to a face image capturing screen displayed on the authentication information input screen when the face image is to be registered as the authentication information. The control unit 400 may automatically shift to the face image capturing screen when the customer selects the face image as the type of authentication information to be registered.

The membership registration terminal 4 may be configured to acquire biometric information other than the face image, such as information about veins or fingerprints. In this case, the control unit 400 may acquire, as one of the plurality of pieces of authentication information, biometric information read from an apparatus that reads the biometric information.

When the transmission key 481 is operated by the customer, the control unit 400 generates the membership number, associates the plurality of pieces of authentication information, the number information used for member identification, and the payment medium information stored in the membership registration unit 431 with the generated membership number, and transmits such information to the customer server 5.

The camera 49 captures the face image of the customer. For example, the camera 49 captures the face image of the customer when a face imaging screen is displayed due to an operation of the customer and an instruction to capture the face image is issued via the screen. In this case, the control unit 400 acquires the captured face image as one piece of authentication information, and stores the authentication information in the membership registration unit 431. The control unit 400 may store an identification code for identifying the captured face image as the authentication information in the membership registration unit 431.

The card reading unit 106 reads information in the inserted payment medium (for example, credit card information). At the time of membership registration, the customer causes the card reading unit 106 to read one or a plurality of payment media available for settlement of a merchandise purchased in the store T thereafter. The control unit 400 stores, in the membership registration unit 431, the payment medium information read by the card reading unit 106 from the inserted payment medium.

The control unit 400 is connected to a communication unit 107 via the bus 45. The communication unit 107 is communicably connected, via the communication line L, to the registration machine 7, the store server 3, the customer server 5, and the checkout machine 9.

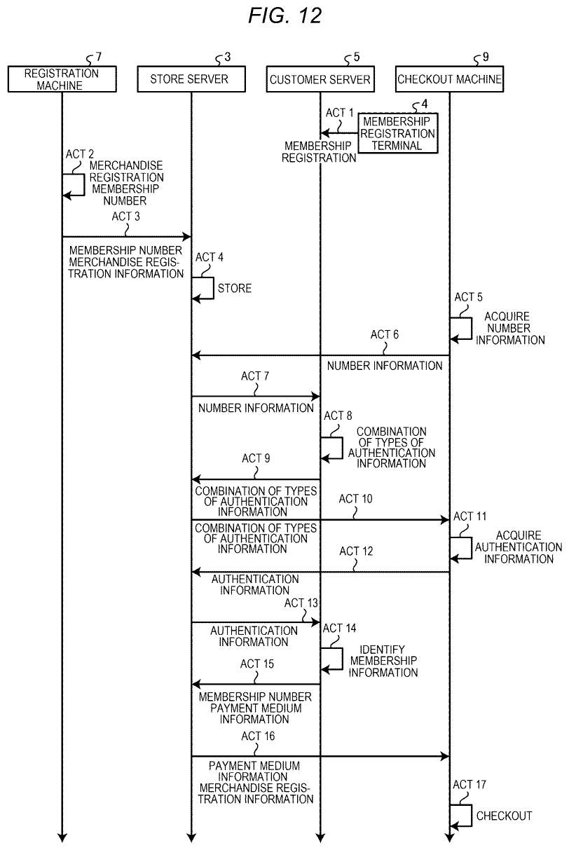

Hereinafter, a flow of an entire process including transmission and reception of information from merchandise registration to settlement in the registration machine 7, the store server 3, the customer server 5, and the checkout machine 9 will be described. FIG. 12 is a sequence diagram showing a flow of a process among the registration machine 7, the store server 3, the customer server 5, and the checkout machine 9.

First, the customer server 5 receives the membership information (the membership number, the plurality of pieces of authentication information, the number information used for member identification, and the payment medium information associated with one another) from the membership registration terminal 4 and stores the membership information in the membership management unit 531, thereby performing the membership registration for the corresponding member (ACT1). In this case, the control unit 500 of the customer server 5 is an example of a registration unit. The process related to the membership registration described above may be performed by the control unit 400 of the membership registration terminal 4.

The store clerk or the customer of the store T uses the registration machine 7 to perform the merchandise registration operation of the merchandise purchased by the customer. The registration machine 7 performs the merchandise registration process for the merchandise (ACT2). The registration machine 7 reads the membership number from the read membership card when the member performs the merchandise registration (ACT2). Then, the registration machine 7 transmits the merchandise registration information of the merchandise subjected to the merchandise registration process and the read membership number to the store server 3 in association with each other (ACT3).

The store server 3 stores, in the membership information unit 332, the membership number and the merchandise registration information received from the registration machine 7 in association with each other (ACT4).

When the merchandise registration process in the registration machine 7 ends, the customer moves to any available checkout machine 9 and inputs start of a checkout process at the checkout machine 9. At this time, the checkout machine 9 displays a number input screen on the display 47. The customer inputs a numerical value indicating the number of pieces of authentication information used for identifying the member via the number input screen.

As an example, the number input screen displays a message such as “please input the number of pieces of authentication information to be used for member identification set by yourself at the time of membership registration” and a form for inputting the numerical value.

The checkout machine 9 acquires number information (second number information) used for the settlement process based on the input numerical value (ACT5). The checkout machine 9 transmits, to the store server 3, the acquired number information used for the settlement process (ACT6). The store server 3 transmits, to the customer server 5, the number information used for the settlement process received from the checkout machine 9 (ACT7).

The customer server 5 determines a combination of types of authentication information used for member identification based on the number information used for the settlement process received from the store server 3 (ACT8). For example, the customer server 5 determines the combination of types of authentication information used for member identification by randomly selecting, from the plurality of types of authentication information adopted in the store T, a number of types of authentication information corresponding to the number information used for the settlement process received from the store server 3.

The customer server 5 transmits the determined combination of types of authentication information to the store server 3 (ACT9). The store server 3 transmits, to the checkout machine the 9, combination of types of authentication information received from the customer server 5 (ACT10). The checkout machine 9 displays, on the display 47, the authentication information input screen for inputting authentication information corresponding to the combination of types of authentication information received from the store server 3. The customer inputs a character string corresponding to a plurality of pieces of authentication information via the authentication information input screen.

When the face image is contained in the combination of types of authentication information, the checkout machine 9 captures the face image of the customer with the camera 101 according to an instruction of the customer.

It is also conceivable that there is a type of authentication information that is not necessarily registered among the plurality of types of authentication information adopted in the store T. Therefore, in such a situation, a case where the combination of types of authentication information determined by the customer server 5 includes a type of authentication information that is not registered by the customer will be described.

In this case, the checkout machine 9 may transmit, to the customer server 5 via the store server 3, information indicating that a type of unregistered authentication information is contained in the combination of types of authentication information determined by the customer server 5. The customer server 5 that receives the information may determine the combination of types of authentication information again.

The checkout machine 9 acquires, based on the input character string or the captured face image, the plurality of pieces of authentication information corresponding to the combination of types of authentication information received from the store server 3 (ACT11). The checkout machine 9 transmits the acquired plurality of pieces of authentication information to the store server 3 (ACT12). That is, the checkout machine 9 inquires, based on the plurality of pieces of authentication information, the merchandise registration information related to the customer. The store server 3 transmits, to the customer server 5, the plurality of pieces of authentication information received from the checkout machine 9 (ACT13).

The customer server 5 searches the membership management unit 531 based on the plurality of pieces of authentication information received from the store server 3, and identifies a membership number associated with a plurality of pieces of authentication information matching the received plurality of pieces of authentication information, the number information used for member identification, and the payment medium information (membership information) (ACT14).

It is conceivable that the membership number may not be uniquely identified even when there are a plurality of pieces of authentication information matching the plurality of pieces of authentication information received from the store server 3 in the membership management unit 531.

In this case, the customer server 5 may transmit, to the checkout machine 9 via the store server 3, information for requesting transmission of information (for example, the mobile phone number, the my number, or the face image) that can uniquely identify the membership number. In this case, it is preferable that the store T sets in advance at least one piece of information among the information that can uniquely specify the membership number as authentication information necessary for registration.

Although not shown in FIG. 12, when the number information used for the settlement process transmitted from the store server 3 in ACT7 does not match the number information used for member identification identified in ACT14, the customer server 5 transmits a control command to stop the settlement process to the checkout machine 9 via the store server 3. Similarly, when there is no membership information associated with the plurality of pieces of authentication information matching the received plurality of pieces of authentication information in the membership management unit 531, the customer server 5 may transmit the control command to stop the settlement process to the checkout machine 9.

After identifying the membership information, the customer server 5 associates the identified membership number with the payment medium information and transmits such information to the store server 3 (ACT15). The store server 3 that receives the membership number and the payment medium information from the customer server 5 stores the payment medium information in the membership information unit 332 in association with the received membership number. The store server 3 reads the merchandise registration information and the payment medium information stored in association with the membership number and transmits such information to the checkout machine 9 that issues the inquiry (ACT16).

The checkout machine 9 performs the settlement process for the member based on the received merchandise registration information and the received payment medium information (ACT17). When the control command to stop the settlement process is received from the store server 3, the checkout machine 9 stops the settlement process. In this case, the checkout machine 9 may display on the display 47 that there is an error in the received information (the authentication information and the number information used for the settlement process).

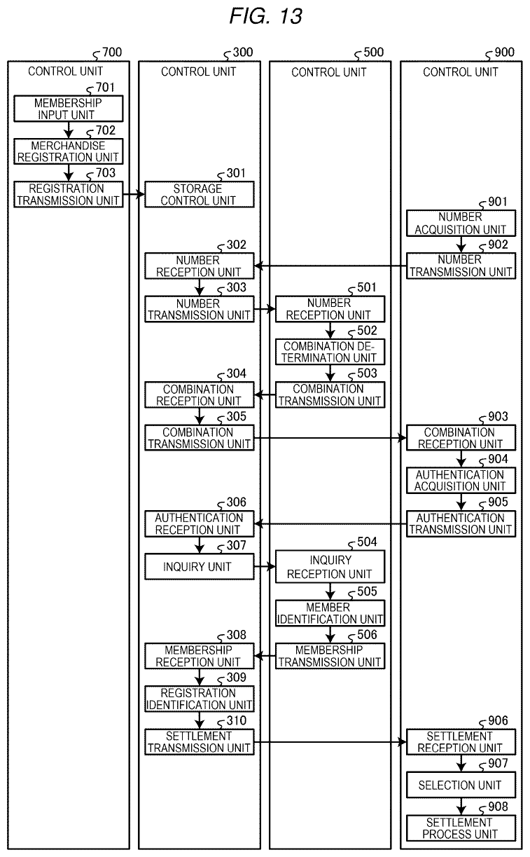

Hereinafter, functional configurations of the registration machine 7, the store server 3, the customer server 5, and the checkout machine 9 from the merchandise registration to the settlement will be described. FIG. 13 is a functional block diagram showing an example of the functional configurations of the registration machine 7, the store server 3, the customer server 5, and the checkout machine 9.

The control unit 700 of the registration machine 7 functions as a membership input unit 701, a merchandise registration unit 702, and a registration transmission unit 703 by following the control program stored in the ROM 72 or the control program unit 741 of the memory unit 74.

The membership input unit 701 receives input of the membership number for identifying the member. Specifically, the membership input unit 701 reads the membership number of the member from the membership card inserted into the card reading unit 83.

The merchandise registration unit 702 performs the merchandise registration process of the merchandise. Specifically, the merchandise registration unit 702 performs the merchandise registration process for a merchandise identified by an image of the merchandise captured by the scanner 82.

The registration transmission unit 703 transmits the membership number input by the membership input unit 701 and the merchandise registration information of the merchandise subjected to the merchandise registration process by the merchandise registration unit 702 to the store server 3 in association with each other.

The control unit 300 of the store server 3 functions as a storage control unit 301, a number reception unit 302, a number transmission unit 303, a combination reception unit 304, a combination transmission unit 305, an authentication reception unit 306, an inquiry unit 307, a membership reception unit 308, a registration identification unit 309, and a settlement transmission unit 310 by following the control program stored in the ROM 32 or the control program unit 341 of the memory unit 34.

The storage control unit 301 further associates the payment medium information received from the customer server 5 with the membership number and the merchandise registration information received from the registration machine 7, and stores such information in the membership information unit 332.

The number reception unit 302 determines whether the number information used for member identification is received from the checkout machine 9.

The number transmission unit 303 transmits, to the customer server 5, the number information used for member identification for which it is determined that the number reception unit 302 receives the number information used for member identification.

The combination reception unit 304 determines whether the combination of types of authentication information used for member identification is received from the customer server 5.

The combination transmission unit 305 transmits, to the checkout machine 9, the combination of types of authentication information for which it is determined that the combination reception unit 304 receives the combination of types of authentication information.

The authentication reception unit 306 determines whether the plurality of pieces of authentication information for identifying the member are received from the checkout machine 9.

The inquiry unit 307 transmits, to the customer server 5, the plurality of pieces of authentication information determined as being received by the authentication reception unit 306. In other words, based on the plurality of pieces of authentication information determined as being received by the authentication reception unit 306, the inquiry unit 307 inquires of the customer server 5 about the number information and the payment medium information used for member identification related to the member.

The membership reception unit 308 determines whether the membership number and the payment medium information associated with the plurality of pieces of authentication information are received from the customer server 5 in response to the plurality of pieces of authentication information transmitted by the inquiry unit 307. In addition, the membership reception unit 308 determines whether the control command to stop the settlement process is received from the customer server 5.

The registration identification unit 309 identifies the membership number stored in the membership information unit 332 by the storage control unit 301, and the merchandise registration information and the payment medium information associated with the membership number, which are determined as being received by the membership reception unit 308.

The settlement transmission unit 310 transmits the merchandise registration information and the payment medium information identified by the registration identification unit 309 to the checkout machine 9 where the authentication information is transmitted. In addition, the settlement transmission unit 310 transmits, to the checkout machine 9, the control command to stop the settlement process, which is determined as being received by the membership reception unit 308.

The control unit 500 of the customer server 5 functions as a number reception unit 501, a combination determination unit 502, a combination transmission unit 503, an inquiry reception unit 504, a member identification unit 505, and a membership transmission unit 506 by following the control program stored in the ROM 52 or the control program unit 541 of the memory unit 54.

The number reception unit 501 determines whether the number information used for the settlement process transmitted by the number transmission unit 303 is received.

The combination determination unit 502 (an example of a determination unit) determines the combination of types of authentication information used for member identification based on the number information used for the settlement process determined as being received by the number reception unit 501.

For example, the combination determination unit 502 randomly selects, from the plurality of types of authentication information adopted in the store T, a number of types of authentication information corresponding to the received number information used for the settlement process. The combination determination unit 502 determines the randomly selected combination of types of authentication information as the combination of types of authentication information used for member identification.

When one or more pieces of information that can uniquely identify the membership number are registered, the combination determination unit 502 may determine the combination of types of authentication information used for member identification in such a manner that at least one piece of the information that can uniquely identify the membership number is contained. Accordingly, it is possible to prevent a situation in which the membership number cannot be uniquely identified based on the determined combination of types of authentication information used for member identification.

The combination transmission unit 503 transmits, to the store server 3, the combination of types of authentication information used for member identification determined by the combination determination unit 502.

The inquiry reception unit 504 determines whether the plurality of pieces of authentication information transmitted by the inquiry unit 307 are received.

The member identification unit 505 (an example of an identification unit) identifies the member. For example, the member identification unit 505 searches the membership management unit 531 based on the plurality of pieces of authentication information determined as being received by the inquiry reception unit 504, and identifies the membership number stored in association with the plurality of pieces of authentication information, the number information used for member identification, and the payment medium information.

For example, the member identification unit 505 determines whether the number information used for the settlement process determined as being received by the number reception unit 501 matches the identified number information used for member identification.

When the member identification unit 505 determines that the number information used for the settlement process determined as being received by the number reception unit 501 matches the identified number information used for member identification, the membership transmission unit 506 transmits the membership number identified by the member identification unit 505 and the payment medium information to the store server 3. In other words, when the two pieces of number information match each other, the member identification unit 505 permits execution of the settlement process. The membership transmission unit 506 in this case is an example of a control unit.

When it is determined that the number information used for the settlement process determined as being received by the number reception unit 501 does not match the identified number information used for member identification, the member identification unit 505 transmits, to the store server 3, the control command to cause the checkout machine 9 to stop the settlement process. In other words, when the two pieces of number information do not match each other, the member identification unit 505 inhibits the execution of the settlement process. The member identification unit 505 in this case is an example of a control unit.

The control unit 900 of the checkout machine 9 functions as a number acquisition unit 901, a number transmission unit 902, a combination reception unit 903, an authentication acquisition unit 904, an authentication transmission unit 905, a settlement reception unit 906, a selection unit 907, and a settlement process unit 908 by following the control program stored in the ROM 92 or the control program unit 941 of the memory unit 94.

The number acquisition unit 901 (an example of an acquisition unit) acquires the number information used for the settlement process. Specifically, when a start operation of the settlement process is received from the customer, the number acquisition unit 901 acquires, via the number input screen displayed on the display 47, a numerical value input as the number of types of the authentication information used for member identification as the number information used for the settlement process.

The number transmission unit 902 transmits, to the store server 3, the number information used for the settlement process acquired by the number acquisition unit 901.

The combination reception unit 903 determines whether the combination of types of authentication information transmitted by the combination transmission unit 305 is received.

The authentication acquisition unit 904 acquires a plurality of pieces of authentication information corresponding to the combination of types of authentication information determined as being received by the combination reception unit 903. Specifically, when the combination reception unit 903 determines that the combination of types of authentication information is received, the authentication acquisition unit 904 acquires a plurality of pieces of authentication information of the member based on information (an example of input information) input by the customer via the authentication information input screen displayed on the display 47.

When the face image is contained in the combination of types of authentication information determined as being received by the combination reception unit 903, the authentication acquisition unit 904 acquires, as one piece of authentication information, the face image of the customer captured by the customer via the face image capturing screen to which the authentication information input screen can be shifted by an operation of the customer.

The authentication transmission unit 905 transmits, to the store server 3, the plurality of pieces of authentication information acquired by the authentication acquisition unit 904.

The settlement reception unit 906 receives, from the store server 3, the merchandise registration information of the merchandise purchased by the member corresponding to the authentication information transmitted by the authentication transmission unit 905 and the payment medium information for identifying the payment medium used for payment by the member.

Specifically, the settlement reception unit 906 receives, from the store server 3, and stores the merchandise registration information of the merchandise purchased by the member corresponding to the plurality of pieces of authentication information that is acquired by the authentication acquisition unit 904 and transmitted by the authentication transmission unit 905, and the payment medium information for identifying the payment medium used for payment by the member. The settlement reception unit 906 stores the received merchandise registration information in the merchandise registration information unit 933. The settlement reception unit 906 stores the received payment medium information in the medium memory 934.

The settlement reception unit 906 receives, from the store server 3, the control command to stop the settlement process. Specifically, when it is determined that input of the number information or the authentication information used for the settlement process by the customer in the customer server 5 is inadequate, the settlement reception unit 906 receives, from the store server 3, the control command to stop the settlement process.

When there are a plurality of types of payment media available for payment related to the received payment medium information, the selection unit 907 displays the medium selection screen on which any one of the payment media can be selected.

Specifically, when there are a plurality of types of payment media that can be used for payment related to the received payment medium information, the selection unit 907 displays the medium selection screen on which the plurality of payment media contained in the received payment medium information are visually shown, and when any one of the payment media is touched, the payment medium is selected.

The settlement process unit 908 performs the settlement process based on the received merchandise registration information using the payment medium identified by the received payment medium information.

Specifically, when a plurality of payment media are contained in the received payment medium information, the settlement process unit 908 performs the settlement process using the payment medium selected from the payment media available for payment displayed by the selection unit 907. When one payment medium is contained in the received payment medium information, the settlement process unit 908 performs the settlement process using the payment medium without displaying the medium selection screen by the selection unit 907.

When the settlement reception unit 906 receives, from the store server 3, the control command to stop the settlement process, the settlement process unit 908 stops the settlement process. In this case, the settlement process unit 908 may display, on the display 47, a message indicating that the input of the number information or the authentication information used for the settlement process is inadequate.

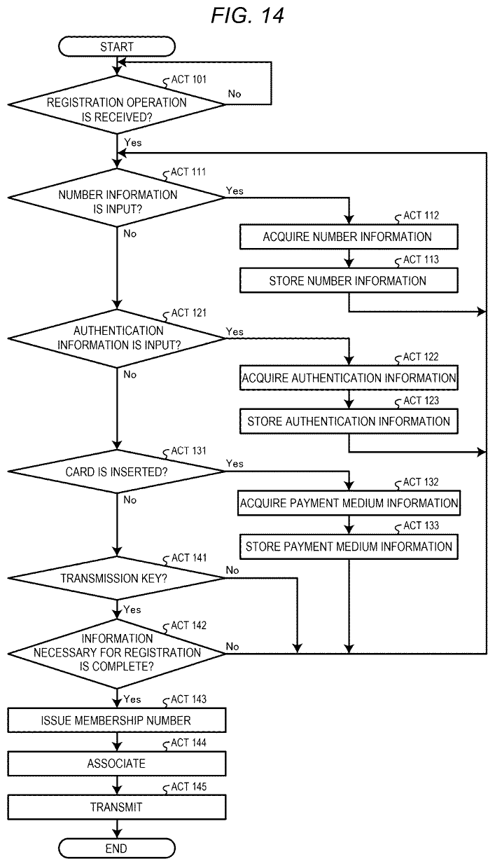

Hereinafter, control of the membership registration terminal 4 will be described. FIG. 14 is a flowchart showing an example of a flow of a control process of the membership registration terminal 4.

As shown in FIG. 14, the control unit 400 of the membership registration terminal 4 determines whether a start operation of a membership registration process is received from the customer (ACT101). For example, the control unit 400 determines whether pressing input on an operation element for performing an operation for starting the membership registration process is received from the customer via a menu screen for performing various processes displayed on the display 47 of the membership registration terminal 4. When it is determined that the start operation of the membership registration process is not received (No in ACT101), the process of ACT101 is repeated.

When it is determined that the start operation of the membership registration process is received (Yes in ACT101), the control unit 400 determines whether input of the number information used for member identification is received from the customer (ACT111). For example, the control unit 400 displays the authentication information input screen on the display 47 when it is determined that the start operation of the membership registration process is received. The control unit 400 determines whether an operation to confirm the input of the number information is received from the customer via the number information form input provided on the authentication information input screen.

When it is determined that the input of the number information is received (Yes in ACT111), the control unit 400 acquires an input content thereof (numerical value) as the number information used for member identification (ACT112). Then, the control unit 400 stores, in the membership registration unit 431, the acquired number information used for member identification (ACT113). Then, the control unit 400 returns the process to ACT111.

When it is determined that the input of the number information is not received (No in ACT111), the control unit 400 determines whether of the authentication input information is received from the customer (ACT121). For example, the control unit 400 determines whether an operation of confirming selection input of the type of authentication information to be registered and an input content corresponding to the selected of authentication type information is received from the customer via the authentication information input screen.

When it is determined that the input of the authentication information is received (Yes in ACT121), the control unit 400 acquires an input content thereof as the authentication information (ACT122). The control unit 400 stores the acquired authentication information in the membership registration unit 431 (ACT123). Then, the control unit 400 returns the process to ACT111.

When it is determined that the input of the authentication information is not received (No in ACT121), the control unit 400 determines whether a card to be used for settlement is inserted into the card reading unit 106 (ACT131).

When it is determined that the card to be used for settlement is inserted into the card reading unit 106 (Yes in ACT131), the control unit 400 reads card information from the inserted card and generates payment medium information related to the card (ACT132). The control unit 400 stores the generated payment medium information in the membership registration unit 431 (ACT133). Then, the control unit 400 returns the process to ACT111.

When it is determined that no card is inserted into the card reading unit 106 (No in ACT131), the control unit 400 determines whether the transmission key 481 is operated (ACT141). When it is determined that the transmission key 481 is not operated (No in ACT141), the control unit 400 returns the process to ACT111.

When it is determined that the transmission key 481 is operated (Yes in ACT141), the control unit 400 determines whether information necessary for membership registration is complete (ACT142).

In the embodiment, the control unit 400 determines whether the number information used for member identification, the plurality of pieces of authentication information (all of the mobile phone number, the my number, the name, the user name, the personal identification number, the character string representing favorite food, and the face image), and the payment medium information are stored in the membership registration unit 431. The plurality of pieces of authentication information may include information other than those described above, or may not include all or a part of the above-described information.

When it is determined that the necessary information is not complete (No in ACT142), the control unit 400 returns the process to ACT111. When it is determined that the necessary information is complete (No in ACT142), the control unit 400 issues the membership number for identifying the member (ACT143).

The control unit 400 stores, in the membership registration unit 431, the issued membership number in association with the authentication information, the number information used for member identification, and the payment medium information stored in the membership registration unit 431 (ACT144). The control unit 400 transmits, to the customer server 5, the membership number, the plurality of pieces of authentication information, the number information used for member identification, and the payment medium information, which are associated with one another (ACT145).

According to the membership registration terminal 4 in such an embodiment, when the customer performs the membership registration, the membership number for identifying the member can be associated with the payment medium information for identifying the payment medium available for the member thereafter. According to the membership registration terminal 4 in the embodiment, it is possible to associate the membership number for identifying the member issued by the store T (may be a company operating the store T) with the plurality of pieces of authentication information through which the member can be identified.

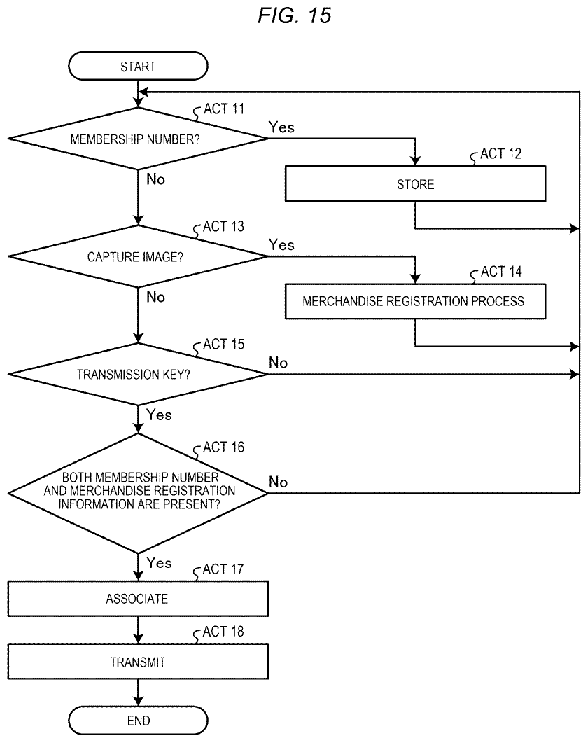

Hereinafter, control of the registration machine 7 will be described. FIG. 15 is a flowchart showing an example of a flow of a control process of the registration machine 7. As shown in FIG. 15, the control unit 700 of the registration machine 7 determines whether the card reading unit 83 reads the membership number (ACT11). When it is determined that the membership number is read (Yes in ACT11), the membership input unit 701 stores the read membership number in the membership number unit 732 (ACT12). Then, the control unit 700 returns the process to ACT11.

When it is determined that the membership number is not read (No in ACT11), the control unit 700 determines whether an image of the merchandise is captured by the scanner 82 (ACT13). When it is determined that the image of the merchandise is captured (Yes in ACT13), the merchandise registration unit 702 identifies the merchandise based on the captured image of the merchandise and performs the merchandise registration process of the merchandise. Then, the merchandise registration unit 702 stores the merchandise registration information in the merchandise information unit 731 (ACT14). Thereafter, the control unit 700 returns the process to ACT11.

When it is determined that no image of the merchandise is captured (No in ACT13), the control unit 700 determines whether the transmission key 772 is operated (ACT15). When it is determined that the transmission key 772 is not operated (No in ACT15), the control unit 700 returns the process to ACT11.

When it is determined that the transmission key 772 is operated (Yes in ACT15), the control unit 700 determines whether both the merchandise registration information and the membership number are present (ACT16). For example, the control unit 700 determines whether the merchandise registration information is stored in the merchandise information unit 731 and the membership number is stored in the membership number unit 732. When it is determined that at least one of the merchandise registration information and the membership number is absent (No in ACT16), the control unit 700 returns the process to ACT11.

When it is determined that both the: merchandise registration information and the membership number are present (Yes in ACT16), the control unit 700 associates the merchandise registration information stored in the merchandise information unit 731 with the membership number stored in the membership number unit 732 (ACT17). The registration transmission unit 703 transmits the merchandise registration information and the membership number, which are associated with each other, to the store server 3 (ACT18). Then, the control unit 700 ends the merchandise registration process for one customer.

According to the registration machine 7 in such an embodiment, by reading the membership number, it is possible to associate the membership number with the merchandise registration information of the merchandise subjected to the merchandise registration process (that is, the merchandise purchased by the member) and transmit the membership number and the merchandise registration information, which are associated with each other, to the store server 3.

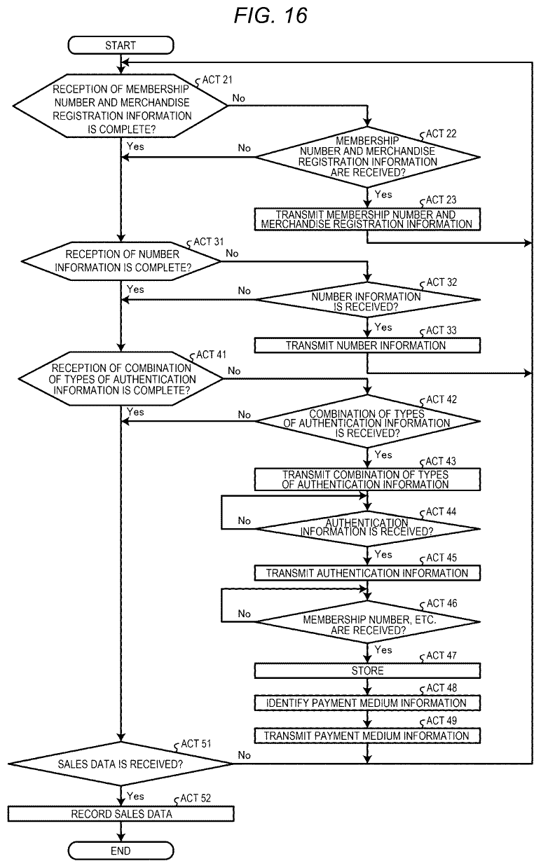

Hereinafter, control of the store server 3 will be described. FIG. 16 is a flowchart showing a flow of a control process of the store server 3.

The control unit 300 of the store server 3 determines whether reception of the membership number and the merchandise registration information, which are associated with each other, from the registration machine 7 is complete (ACT21). When it is determined that the reception is complete (Yes in ACT21), the control unit 300 advances the process to ACT31 to be described later. When it is determined that the reception is not complete (No in ACT21), the control unit 300 determines whether the membership number and the merchandise registration information, which are associated with each other, are received from the registration machine 7 (ACT22).

When it is determined that the membership number and the merchandise registration information are received (Yes in ACT22), the storage control unit 301 stores the received membership number and the received merchandise registration information in the membership information unit 332 (ACT23). Specifically, the storage control unit 301 stores the received membership number in the membership number unit 3321, and stores the received merchandise registration information in the merchandise registration information unit 3322 corresponding to the stored membership number. Then, the control unit 300 returns the process to ACT21.

When it is determined that the membership number and the merchandise registration information are not received (No in ACT22), the number reception unit 302 determines whether reception of the number information used for the settlement process from the checkout machine 9 is complete (ACT31). When it is determined that the reception is complete (Yes in ACT31), the control unit 300 advances the process to ACT41 to be described later. When it is determined that the reception is not complete (No in ACT31), the number reception unit 302 determines whether the number information used for the settlement process is received from the checkout machine 9 (ACT32).

When it is determined that the number information used for the settlement process is received from the checkout machine 9 (Yes in ACT32), the number transmission unit 303 transmits the received number information used for the settlement process to the customer server 5 (ACT33).

Thereafter, the control unit 300 determines whether reception of the combination of types of authentication information from the customer server 5 is complete (ACT41). When it is determined that the reception is complete (Yes in ACT41), the control unit 300 advances the process to ACT51 to be described later. When it is determined that the reception is not complete (No in ACT41), the combination reception unit 304 determines whether the combination of types of authentication information is received from the customer server 5 (ACT42). When it is determined that the combination of types of authentication information is not received from the customer server 5 (No in ACT42), the control unit 300 advances the process to ACT51.

On the other hand, when it is determined that the combination of types of authentication information is received from the customer server 5 (Yes in ACT42), the combination transmission unit 305 transmits the received combination of types of authentication information to the checkout machine 9 (ACT43).

Thereafter, the authentication reception unit 306 determines whether the plurality of pieces of authentication information corresponding to the combination of types of authentication information transmitted in ACT43 are received from the checkout machine 9 (ACT44). When the plurality of pieces of authentication information are not received (No in ACT43), the process stands by until the plurality of pieces of authentication information are received. When it is determined that the plurality of pieces of authentication information are received from the checkout machine 9 (Yes in ACT44), the inquiry unit 307 transmits the received authentication information to the customer server 5 (ACT45).

Thereafter, the membership reception unit 308 determines whether the membership number and the payment medium information, which are associated with each other, are received from the customer server 5 in response to the transmission of the plurality of pieces of authentication information to the customer server 5 by the inquiry unit 307 (ACT46). When the membership number and the payment medium information are not received (No in ACT46), the process stands by until the membership number and the payment medium information are received. When it is determined that the membership number and the payment medium information are received (Yes in ACT46), the storage control unit 301 stores the payment medium information in the membership information unit 332 based on the received membership number (ACT47).

Specifically, the storage control unit 301 stores the received payment medium information in the payment medium unit 3323 associated with the membership number unit 3321 in which the same membership number as the received membership number is stored.

Thereafter, the registration identification unit 309 identifies the merchandise registration information and the payment medium information stored in the membership information unit 332 in association with the received membership number (ACT48). Then, the settlement transmission unit 310 transmits the identified merchandise registration information and the identified payment medium information to the checkout machine 9 that is a transmission source of the plurality of pieces of authentication information received in ACT44 (ACT49). Then, the control unit 300 returns the process to ACT21.

Thereafter, the control unit 300 determines whether the sales data is received from the checkout machine 9 (ACT51). When it is determined that the sales data is not received (No in ACT51), the control unit 300 returns the process to ACT21.

When it is determined that the sales data is received (Yes in ACT51), the storage control unit 301 additionally stores the received sales data in the sales information unit 331 (ACT52), and manages the sales of the store T.

Based on the plurality of pieces of authentication information received from the checkout machine 9, the store server 3 according to such an embodiment can transmit, to the checkout machine 9, the merchandise registration information of the merchandise purchased by the member identified by the plurality of pieces of authentication information and the payment medium information related to the member.

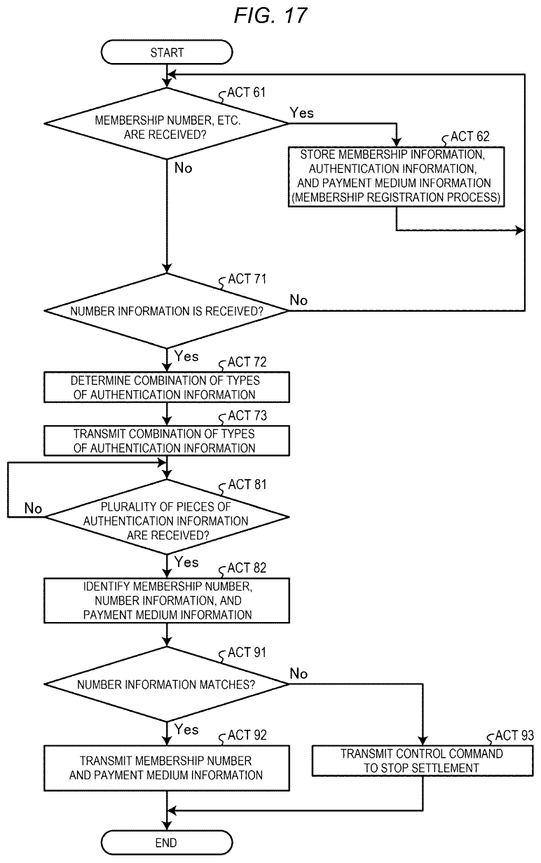

Hereinafter, control of the customer server 5 will be described. FIG. 17 is a flowchart showing an example of a flow of a control process of the customer server 5.

As shown in FIG. 15, the control unit 500 of the customer server 5 determines whether the membership number, the plurality of pieces of authentication information, the number information used for member identification, and the payment medium information, which are associated with one another, are received from the membership registration terminal 4 (ACT61). When it is determined that the membership number, the plurality of pieces of authentication information, the number information used for member identification, and the payment medium information are received (Yes in ACT61), the control unit 500 stores the received membership number, the received plurality of pieces of authentication information, and the received payment medium information in the membership management unit 531, and performs the membership registration process of the member (ACT62).

Specifically, the control unit 500 stores the received membership number in the membership number unit 5311. The control unit 500 stores the received plurality of pieces of authentication information in the authentication information unit 5312. The control unit 500 stores the received number information used for member identification in the number information unit 5313. The control unit 500 stores the received payment medium information in the payment medium unit 5314. Then, the control unit 500 returns the process to ACT61.

When it is determined that the membership number, the plurality of pieces of authentication information, the number information used for member identification, and the payment medium information are not received from the membership registration terminal 4 (No in ACT61), the number reception unit 501 determines whether the number information used for the settlement process is received from the store server 3 (ACT71). When it is determined that the number information used for the settlement process is not received from the store server 3 (No in ACT71), the control unit 500 returns the process to ACT61.

On the other hand, when it is determined that the number information used for the settlement process is received from the store server 3 (Yes in ACT61), the combination determination unit 502 determines the combination of the types of the authentication information used for member identification based on the number information used for the settlement process received in ACT61 (ACT72).

Specifically, the combination determination unit 502 randomly selects, from the plurality of types of authentication information adopted in the store T, a number of types of authentication information corresponding to the received number information to be used for the settlement process. Then, the combination determination unit 502 determines the randomly selected combination of types of authentication information as the combination of types of authentication information used for member identification.

As an example, a case is considered in which a combination of types of authentication information randomly selected from the mobile phone number, the my number, the name, the user name, the personal identification number, the character string representing favorite food, and the face image is the mobile phone number, the my number, and the personal identification number. In this case, the combination determination unit 502 determines the mobile phone number, the my number, and the personal identification number as the combination of types of authentication information used for member identification.

The combination transmission unit 503 transmits the combination of types of authentication information determined in ACT72 to the store server 3 (ACT73).

Thereafter, the inquiry reception unit 504 determines whether the plurality of pieces of authentication information are received from the store server 3 (ACT81). When it is determined that the plurality of pieces of authentication information are not received from the store server 3 (No in ACT81), the control unit 500 stands by until the plurality of pieces of authentication information are received.

On the other hand, when it is determined that the plurality of pieces of authentication information are received from the store server 3 (Yes in ACT81), the member identification unit 505 searches the membership management unit 531 based on the received plurality of pieces of authentication information, and identifies the membership number, the number information used for member identification, and the payment medium information stored in the membership management unit 531 in association with the plurality of pieces of authentication information (ACT82).

Thereafter, the control unit 500 determines whether the number information used for the settlement process received in ACT71 matches the number information used for member identification identified in ACT82 (ACT91). When it is determined that the number information received in ACT71 matches the number information identified in ACT82 (Yes in ACT91), the membership number and the payment medium information identified in ACT82 are transmitted to the store server 3 (ACT92). Then, the control unit 500 ends the process and returns the process to ACT61.

On the other hand, when it is determined that the number information received in ACT71 does not match the number information identified in ACT82 (No in ACT91), the control command to cause the checkout machine 9 to stop the settlement process is transmitted to the store server 3 (ACT93). Then, the control unit 500 ends the process and returns the process to ACT61.

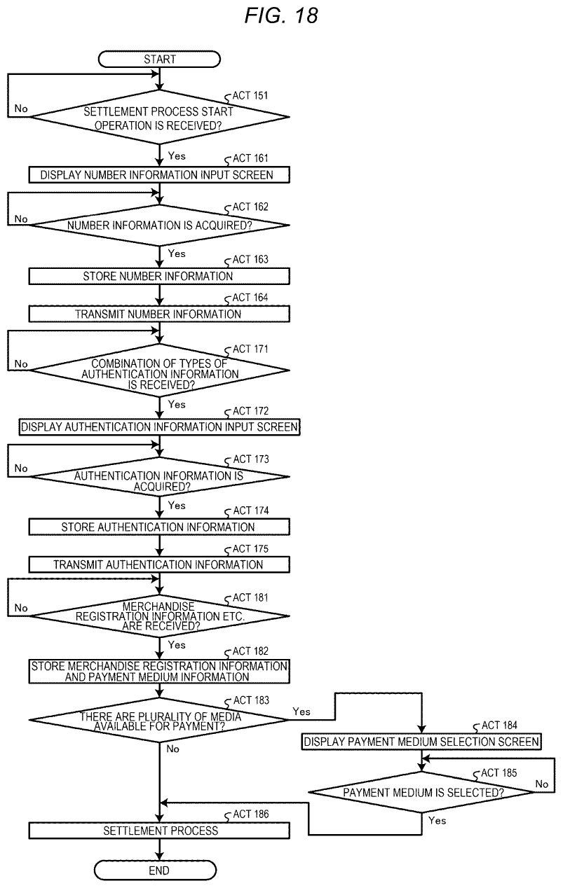

Thereafter, control of the checkout machine 9 will be described. FIG. 18 is a flowchart showing an example of a flow of a control process of the checkout machine 9.

As shown in FIG. 18, the control unit 900 of the checkout machine 9 determines whether input of the start operation of the settlement process is received from the customer (ACT151). For example, the control unit 900 determines whether pressing input on an operation element for performing an operation of starting the settlement process is received from the customer via a menu screen for performing various processes displayed on the display 97 of the checkout machine 9. When it is determined that the start operation of the settlement process is not received (No in ACT151), the process of ACT151 is repeated.

When it is determined that the start operation of the settlement process is received (Yes in ACT151), the control unit 900 displays a number information input screen on the display 97 (ACT161).

Thereafter, the number acquisition unit 901 determines whether the number information used for the settlement process is acquired from the customer (ACT162).

For example, when an operation of confirming input of the number information is received from the customer via the number information input screen displayed on the display 97 in ACT161, the number acquisition unit 901 acquires an input content thereof as the number information used for the settlement process. In this case, the number acquisition unit 901 determines that the number information used for the settlement process is acquired. When it is not determined that the number information used for the settlement process is acquired (No in ACT162), the process stands by until the number information used for the settlement process is acquired.

On the other hand, when it is determined that the number information used for the settlement process is acquired (Yes in ACT162), the number acquisition unit 901 stores the acquired number information used for the settlement process in the number information unit 932 (ACT163). The number transmission unit 902 transmits, to the store server 3, the number information used for the settlement process stored in the number information unit 932 (ACT164).

Thereafter, the combination reception unit 903 determines whether the combination of types of authentication information used for member identification is received from the store server 3 (ACT171). When it is not determined that the combination of types of authentication information is received (No in ACT171), the process stands by until the combination of types of authentication information is received.

On the other hand, when it is determined that the combination of types of authentication information is received (Yes in ACT171), the control unit 900 displays the authentication information input screen on the display 97 (ACT172).

As an example, when the combination of types of authentication information is the mobile phone number, the my number, and the personal identification number, the control unit 900 displays, on the display 97, an authentication information input screen including an input form for inputting the mobile phone number, an input form for inputting the my number, and an input form for inputting the personal identification number. When the face image is contained in the combination of types of authentication information, the control unit 900 may display an operation element for shifting to the face imaging screen on the authentication information input screen.

Thereafter, the authentication acquisition unit 904 determines whether the plurality of pieces of authentication information are acquired from the customer (ACT173). For example, when an operation of confirming input of the authentication information is received from the customer via the number information input screen displayed on the display 97 in ACT172, the authentication acquisition unit 904 acquires an input content as the authentication information.

As an example, a case is considered in which the combination of types of authentication information is the mobile phone number, the my number, and the personal identification number. In this case, when an operation of confirming input is received from the customer for each of the mobile phone number, the my number, and the personal identification number, the authentication acquisition unit 904 acquires input contents corresponding to each of the mobile phone number, the my number, and the personal identification number as the plurality of pieces of authentication information.

In this case, the authentication acquisition unit 904 determines that the plurality of pieces of authentication information are acquired. When it is not determined that the plurality of pieces of authentication information are acquired (No in ACT173), the process stands by until the plurality of pieces of information are acquired.

On the other hand, when it is determined that the plurality of pieces of authentication information are acquired (Yes in ACT173), the authentication acquisition unit 904 stores the acquired plurality of pieces of authentication information in the authentication information unit 931 (ACT174). The authentication transmission unit 905 transmits the authentication information stored in the authentication information unit 931 to the store server 3 (ACT175). That is, the checkout machine 9 transmits the acquired plurality of pieces of authentication information and inquires about information on the member.

Thereafter, the control unit 900 determines whether the merchandise registration information and the payment medium information are received from the store server 3 in response to the transmission the of plurality of pieces of authentication information in ACT175 (ACT181). When it is determined that the merchandise registration information and the payment medium information are not received (No in ACT181), the control unit 900 stands by until the merchandise registration information and the payment medium information are received.

When it is determined that the merchandise registration information and the payment medium information are received (Yes in ACT181), the settlement reception unit 906 stores the received merchandise registration information and the received payment medium information (ACT182).

Specifically, the settlement reception unit 906 stores the received merchandise registration information (the merchandise registration information of the merchandise purchased by the customer who transmits the plurality of pieces of authentication information, including a total amount (payment amount)) in the merchandise registration information unit 933. The received payment medium information (the payment medium information for identifying the payment medium available for payment (settlement process) of the customer who transmits the authentication information) is stored in the medium memory 934.

Thereafter, the control unit 900 determines whether there are a plurality of types of available payment media stored in the medium memory 934 (ACT183).

When the number of available payment media is one (for example, the member C in FIG. 9 has only the credit card A as the available payment medium, and thus there is one available payment medium) (No in ACT183), the settlement process unit 908 uses the payment medium to perform the settlement process using the merchandise registration information stored in the merchandise registration information unit 933 (ACT186). Then, the control unit 900 ends the process.

When it is determined that there are a plurality of available payment media (Yes in ACT183), the selection unit 907 displays, on the display 97, the medium selection screen on which the available payment media stored in the medium memory 934 are displayed (ACT184).

For example, the member A in FIG. 9 corresponds to Yes in ACT183 since there are two types of available payment media, that is, the credit card A and the electronic money A. The member B in FIG. 9 corresponds to Yes in ACT183 since there are two types of available payment media, that is, the credit card B and the code settlement B. Therefore, the medium selection screen displaying the available payment media in ACT184 is displayed for the members A and B.

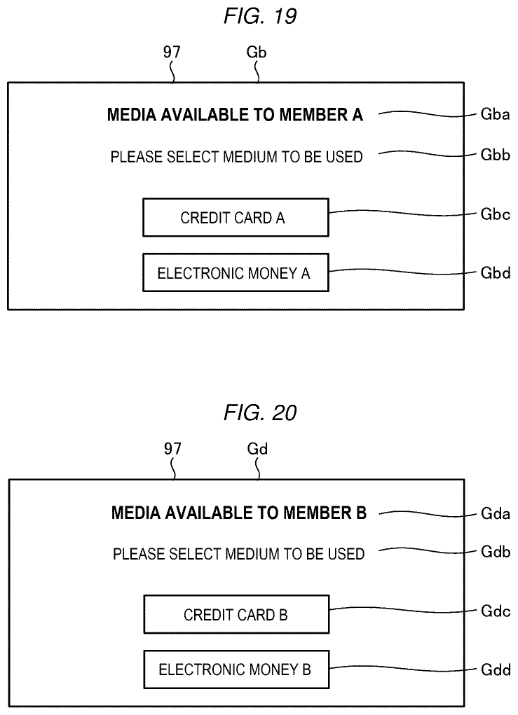

FIG. 19 is an example of the medium selection screen displayed for the member A. As shown in FIG. 19, a medium selection screen Gb related to the member A is displayed on the display 97. The medium selection screen Gb includes a display Gba indicating that a displayed content indicates the payment media available to the member A, a message Gbb prompting the member A to select a payment medium to be used, a display Gbc of the credit card A that is a payment medium available to the member A, and a display Gbd of the electronic money A.

When selecting the credit card A as the payment medium to be used, the member A operates a touch panel key (operation unit 96) at a position corresponding to the display Gbc of the credit card A. When selecting the electronic money A as the payment medium to be used, the member A operates the touch panel key (operation unit 96) at a position corresponding to the display Gbd of the electronic money A.

FIG. 20 is an example of the medium selection screen displayed for the member B. As shown in FIG. 20, a medium selection screen Gd related to the member B is displayed on the display 97. The medium selection screen Gd includes a display Gda indicating that a displayed content indicates the payment media available to the member B, a message Gdb prompting the member B to select the payment medium to be used, a display Gdc of the credit card B that is a payment medium available to the member B, and a display Gdd of the code settlement B.

When selecting the credit card B as the payment medium to be used, the member B operates the touch panel key (operation unit 96) at a position corresponding to the display Gdc of the credit card B. When selecting the code settlement B as the payment medium to be used, the member B operates the touch panel key (operation unit 96) at a position corresponding to the display Gdd of the code settlement B.

Thus, the available payment media displayed on the medium selection screen are different between the member A and the member B. That is, since the checkout machine 9 displays the payment media registered in advance by the member at the time of the membership registration as the available payment media, the payment media registered by the member are displayed for each member in ACT184.

The description returns to FIG. 18. Thereafter, the control unit 900 determines whether any one of the payment media is selected (ACT185). When no payment medium is selected (No in ACT185), the control unit 900 stands by until the payment medium is selected.

On the other hand, when it is determined that any one of the payment medium is selected (Yes in ACT185), the settlement process unit 908 performs the settlement process related to the merchandise registration information stored in the merchandise registration information unit 933 using the selected payment medium (ACT186). In the settlement process, the control unit 900 issues a receipt on which the merchandise registration information of the merchandise purchased by the member, the settlement information, and the like are printed. Then, the control unit 900 ends the process.

When there is one available payment medium stored in the medium memory 934 (No in ACT183), the process of ACT184 is not performed and the medium selection screen is not displayed (for example, in the case of the member C in FIG. 9, no medium selection screen is displayed). That is, when there is one available payment medium, it is not necessary to select the payment medium, and thus the settlement process using the payment medium is automatically performed without displaying the medium selection screen.

The checkout machine 9 in the embodiment transmits the acquired plurality of pieces of authentication information to the store server 3, and performs the settlement process based on the merchandise registration information and the payment medium information of the merchandise purchased by the member received as a response. Therefore, it is not necessary to cause the checkout machine 9 to read the membership card.

When there are a plurality of available payment media registered in advance, the checkout machine 9 in the embodiment displays the medium selection screen on which the payment media are displayed. Therefore, when the member selects one payment medium from the displayed payment media, the checkout machine 9 performs the settlement process using the payment medium. When there is one payment medium registered in advance, the settlement process is automatically performed using the payment medium without displaying the medium selection screen. Therefore, it is not necessary to select the payment medium to be used for the settlement process on the checkout machine 9.

As described above, the merchandise sales data processing system 1 according to the embodiment acquires the plurality of pieces of authentication information, receives from the store server 3, based on the acquired plurality of pieces of authentication information, the merchandise registration information of the merchandise purchased by the member identified by plurality the of pieces of authentication information and the payment medium information for identifying the payment medium used for payment by the member, and performs the settlement process relative to the merchandise registration information using the payment medium information without reading the payment medium.

The merchandise sales data processing system 1 according to the embodiment receives, from the store server 3, the merchandise registration information and the payment medium information of the merchandise purchased by the member corresponding to the acquired plurality of pieces of authentication information of the member, and performs the settlement process based on the merchandise registration information and the payment medium information. Therefore, it is not necessary to read the membership card on the checkout machine 9.

The merchandise sales data processing system 1 according to the embodiment registers the plurality of types of authentication information, randomly determines a plurality of types of authentication information to be used for identifying the member, acquires the authentication information corresponding to each of the determined plurality of types of authentication information, and identifies the member based on the acquired plurality of pieces of authentication information. Further, the merchandise sales data processing system 1 according to the embodiment stops the settlement process when there is no member that can be identified based on the acquired plurality of pieces of authentication information.

In the merchandise sales data processing system 1 according to such an embodiment, the plurality of pieces of authentication information used for member identification are randomly determined each time the settlement process is performed. In the merchandise sales data processing system 1 according to the embodiment, the settlement process is not performed unless all of the plurality of pieces of authentication information input by the customer match the plurality of pieces of registered authentication information. Therefore, for example, even when one of the plurality of pieces of registered authentication information is known to another person, it is possible to prevent the settlement process from being performed by the other person. That is, according to the merchandise sales data processing system 1 according to the embodiment, it is possible to improve security in the settlement process.

In the above-described embodiment, when one payment medium is available, the medium selection screen is not displayed. However, the disclosure is not limited thereto, and the medium selection screen may be displayed even when one payment medium is available.

In the above-described embodiment, the registration machine 7, the store server 3, and the checkout machine 9 are described as the merchandise sales data processing system 1. However, the disclosure is not limited thereto, and the merchandise sales data processing system 1 may include at least the registration machine 7 and the checkout machine 9, may additionally include the store server 3 and the customer server 5, or may further include the membership registration terminal 4. The registration machine 7 and the checkout machine 9 may be implemented as a single integrated apparatus.

In the above-described embodiment, the checkout machine 9 may include a part or all of the functions of the store server 3, the membership registration terminal 4, the customer server 5, and the registration machine 7. For example, in the above-described embodiment, the checkout machine 9 may include the function (registration unit) related to the membership registration process of the customer server 5, the combination determination unit 502, the member identification unit 505, the membership transmission unit 506, and the membership management unit 531.

In the above-described embodiment, the membership number is described as the member identification information. However, the disclosure is not limited thereto, and for example, the customer code or the like stored in the membership card or the like issued to the member may serve as the member identification information. The member identification information may be stored or displayed by a medium issued to the member other than the card.

In the above-described embodiment, the customer server 5 retains the number information used for member identification, and when the number information used for the settlement process acquired by the checkout machine 9 at the time of the settlement process is not matched, the control command to stop the settlement process is transmitted to the checkout machine 9 via the store server 3. However, the process of each functional unit for the number information is not essential. In this case, the combination determination unit 502 of the customer server 5 may randomly determine the number of types of authentication information used for member identification.

The program executed by the checkout machine 9 in the above-described embodiment is provided by being recorded in a computer-readable non-transitory recording medium such as a CD-ROM, a flexible disk (FD), a CD-R, or a digital versatile disk (DVD) as a file in an installable format or an executable format.

The program executed by the checkout machine 9 in the embodiment may be stored in a computer connected to a network such as the Internet and provided by being downloaded via the network. The program executed by the checkout machine 9 in the embodiment may be provided or distributed via a network such as the Internet.

The program executed by the checkout machine 9 in the embodiment may be provided by being incorporated in a ROM or the like in advance.

Although the embodiment of the disclosure is described above, the embodiment is presented as an example, and is not intended to limit the scope of the disclosure. The embodiment can be implemented in various other forms, and various omissions, replacements, changes, and combinations can be made without departing from the gist of the disclosure. The embodiment and the modifications thereof are within the scope and the gist of the disclosure, and are within a scope of the disclosure disclosed in the claims and equivalents thereof.

What is claimed is:

1. A merchandise sales data processing apparatus, comprising:
a registration component configured to register, in a memory, a plurality of types of identification information related to identification of a user;
a determination component configured to determine, from the plurality of types of identification information, a type of each of a plurality of pieces of the identification information used for the identification of the user;
an identification component configured to identify the user based on the identification information corresponding to a respective determined type of the plurality of pieces of the identification information and input information input from the user corresponding to the respective type of the plurality of pieces of the identification information; and
a controller configured to permit the user to use a service related to a commercial transaction when the user is identifiable by the identification component.

2. The merchandise sales data processing apparatus according to claim 1, wherein
the controller inhibits use of the service when the user is not identifiable by the identification component.

3. The merchandise sales data processing apparatus according to claim 1, wherein
the registration component registers the plurality of types of the identification information and information indicating the service that is available in association with each other, and
the controller permits use of the service associated with the identification information when the user is identifiable by the identification component.

4. The merchandise sales data processing apparatus according to claim 1, wherein
the determination component randomly determines the number of the types of the identification information used for the identification of the user.

5. The merchandise sales data processing apparatus according to claim 1, wherein
the registration component registers first number information indicating the number of the types of the plurality of pieces of the identification information used for the identification of the user in association with the identification information,
the merchandise sales data processing apparatus further comprises an acquisition component configured to acquire, from the user, a second number information for using the service when the use of the service is started,
the determination component determines, according to the second number information, the number of the types of the identification information used for the identification of the user, and
when the user is identifiable by the identification component whereas the first number information and the second number information do not match, the controller inhibits use of the service for the identified user.

6. The merchandise sales data processing apparatus according to claim 1, wherein
the identification information includes a plurality of types of first information through which the user is uniquely identifiable and a plurality of types of second information that is set by the user and related to authentication of the user, and
the determination component determines types of the plurality of pieces of the identification information including at least one type of the first information.

7. The merchandise sales data processing apparatus according to claim 1, wherein
the plurality of types of identification information related to identification of the user comprise at least one of a membership card, a membership number, a password, a machine readable membership symbol, a facial image, a finger print image, and an iris scan.

8. A merchandise sales data processing method comprising:
registering, in a memory, a plurality of types of identification information related to identification of a user;
determining, from the plurality of types of identification information, a type of each of a plurality of pieces of the identification information used for the identification of the user;
identifying the user based on the identification information corresponding to a respective determined type of the plurality of pieces of the identification information and input information input from the user corresponding to the respective type of the plurality of pieces of the identification information; and
permitting the user to use a service related to a commercial transaction when the user is identifiable.

9. The merchandise sales data processing method according to claim 8, wherein
the controller inhibits use of the service when the user is not identifiable by the identification component.

10. The merchandise sales data processing method according to claim 8, wherein
the registration component registers the plurality of types of the identification information and information indicating the service that is available in association with each other, and
the controller permits use of the service associated with the identification information when the user is identifiable by the identification component.

11. The merchandise sales data processing method according to claim 8, wherein
the determination component randomly determines the number of the types of the identification information used for the identification of the user.

12. The merchandise sales data processing method according to claim 8, further comprising:
registering first number information indicating the number of the types of the plurality of pieces of the identification information used for the identification of the user in association with the identification information;
acquiring, from the user, a second number information for using the service when the use of the service is started;
determining, according to the second number information, the number of the types of the identification information used for the identification of the user; and
when the user is identifiable by the identification component whereas the first number information and the second number information do not match, inhibiting use of the service for the identified user.

13. The merchandise sales data processing method according to claim 8, wherein
the identification information includes a plurality of types of first information through which the user is uniquely identifiable and a plurality of types of second information that is set by the user and related to authentication of the user, and further comprising:
determining types of the plurality of pieces of the identification information including at least one type of the first information.

14. A semi-self-service-type checkout system, comprising:
a registration component configured to register, in a memory, a plurality of types of identification information related to identification of a user;
a determination component configured to determine, from the plurality of types of identification information, a type of each of a plurality of pieces of the identification information used for the identification of the user;
an identification component configured to identify the user based on the identification information corresponding to a respective determined type of the plurality of pieces of the identification information and input information input from the user corresponding to the respective type of the plurality of pieces of the identification information; and
a controller configured to permit the user to use a service related to a commercial transaction when the user is identifiable by the identification component.

15. The semi-self-service-type checkout system according to claim 14, wherein
the controller inhibits use of the service when the user is not identifiable by the identification component.

16. The semi-self-service-type checkout system according to claim 14, wherein
the registration component registers the plurality of types of the identification information and information indicating the service that is available in association with each other, and
the controller permits use of the service associated with the identification information when the user is identifiable by the identification component.

17. The semi-self-service-type checkout system according to claim 14, wherein
the determination component randomly determines the number of the types of the identification information used for the identification of the user.

18. The semi-self-service-type checkout system according to claim 14, wherein
the registration component registers first number information indicating the number of the types of the plurality of pieces of the identification information used for the identification of the user in association with the identification information,
the merchandise sales data processing apparatus further comprises an acquisition component configured to acquire, from the user, a second number information for using the service when the use of the service is started,
the determination component determines, according to the second number information, the number of the types of the identification information used for the identification of the user, and
when the user is identifiable by the identification component whereas the first number information and the second number information do not match, the controller inhibits use of the service for the identified user.

19. The semi-self-service-type checkout system according to claim 14, wherein
the identification information includes a plurality of types of first information through which the user is uniquely identifiable and a plurality of types of second information that is set by the user and related to authentication of the user, and
the determination component determines types of the plurality of pieces of the identification information including at least one type of the first information.

20. The semi-self-service-type checkout system according to claim 14, wherein
the plurality of types of identification information related to identification of the user comprise at least one of a membership card, a membership number, a password, a machine readable membership symbol, a facial image, a finger print image, and an iris scan.
